(19) United States
(12) Patent Application Publication
(10) Pub. No.: US 2016/0321953 A1
(43) Pub. Date: Nov. 3, 2016

(54) PRONUNCIATION LEARNING SUPPORT SYSTEM UTILIZING THREE-DIMENSIONAL MULTIMEDIA AND PRONUNCIATION LEARNING SUPPORT METHOD THEREOF

(71) Applicant: Jin Ho KANG, Seoul (KR)

(72) Inventor: Jin Ho KANG, Seoul (KR)

(73) Assignee: Becos Inc., Seoul (KR)

(21) Appl. No.: 15/108,318

(22) PCT Filed: Dec. 24, 2014
(86) PCT No.: PCT/KR2014/012850

§ 371 Date: Jun. 27, 2016

(30) Foreign Application Priority Data
Dec. 26, 2013 (KR) 10-2013-0163530

(51) Int. Cl. G09B 19/04

(52) U.S. Cl. CPC G09B 19/04

(57) ABSTRACT

A pronunciation learning support system of the present invention comprises the steps of: acquiring at least one part of recommended air current information data including information on an air current flowing through an inner space of an oral cavity and recommended resonance point information data including information on a location on an articulator where a resonance is generated, during vocalization for a pronunciation corresponding to each subject to be pronounced; and providing an image by processing at least one of a process for displaying specific recommended air current information data corresponding to a specific subject to be pronounced, in the inner space of the oral cavity in an image being provided on a basis of a first perspective direction and a process for displaying, at a specific location on the articulator, specific recommended resonance point information data corresponding to the specific subject to be pronounced.

### TECHNICAL FIELD

The present invention relates to a pronunciation-learning support system using three-dimensional (3D) multimedia and a method of processing information by the system, and more particularly, to a pronunciation-learning support system using 3D multimedia and including a pronunciation-learning support means for accurate and efficient pronunciation learning based on a 3D internal articulator image and a method of processing information by the system.

### BACKGROUND ART

These days, due to a trend toward the specialization of industries and internalization, the learning of foreign languages necessary for respective fields is getting more important every day. Because of this importance, many people spend a lot of time on learning of foreign languages, and various online and offline foreign language courses are being opened accordingly.

In the case of grammar and lexical learning among various fields of the learning of foreign languages, it is easy to understand accurate differences in meaning and structure between a native language and a foreign language through written books and so on. However, in the case of pronunciation learning which is the most basic means of communication, it is difficult to accurately imitate particular pronunciations of a foreign language that do not exist in a native language. In the case of English, there is difference in pronunciation methods of particular phonemes between countries where English is used as a native language. Also, since there is difference in phonetics, written learning material may vary in content according to the English pronunciation of a country in which the learning material was written. Even when a person uses English as his or her native language, it may be difficult to deliver and understand accurate information unless he or she accurately understands a difference in pronunciation between countries and a difference in dialect and accent between areas. For these reasons, in the case of English pronunciation learning, the learning of the North American pronunciation or British pronunciation which are most frequently used all over the world as the correct standard English pronunciation is emphasized from the initial stage to increase efficiency in learning. To develop a capability of inputting and outputting a correct foreign language, a huge amount of money is being spent on English kindergartens, English institutes, one-to-one phonics learning at home, etc. from early childhood before school age.

Also, due to an internalization policy, the number of domestic foreign residents and immigrants is continuously increasing, and accordingly the number of foreigners who have acquired or are trying to acquire Korean nationality is continuously increasing. However, even when foreigners learn Korean, it is similarly necessary to understand a difference in a phonetic system between Korean and their native languages, and they may also have difficulties with the learning of the Korean pronunciation and communication in Korean unless their native languages have sounds similar to particular Korean pronunciations. Not only domestic foreign adult residents and immigrants but also second-generation children who are born with Korean nationality through international marriages, which are continuously increasing with the increase in the number of immigrants, encounter such difficulties with the learning of the Korean pronunciation. However, the number of linguistic experts who are trained to overcome such a difficulty in language learning are very limited, and the cost of language learning may be a heavy burden to immigrant families with low incomes. Accordingly, it is urgently necessary to develop a means and a medium for such foreign language learners to efficiently learn standard Korean pronunciation at low costs.

In general, learning and correction of pronunciation are performed in a one-to-one instruction manner with a foreign teacher. In this case, learning English requires high cost. Also, since the learning is performed at a fixed time, participation of people living busy daily lives, such as office workers, in learning is very limited.

Therefore, a program, etc. is required for a person to effectively learn English pronunciation, vocalization, etc., alone, compare his or her pronunciation with native pronunciation, and evaluate his or her pronunciation by himself or herself during his or her free time.

To meet such a demand, language learning devices in which various linguistic programs using speech recognition or speech waveform analysis are installed have been developed and are currently being spread.

Such a language learning device evaluates English pronunciation based on a pronunciation comparison method using speech signal processing technology. Here, programs for recognizing pronunciation of a learner using a hidden Markov model (HMM) which compare pronunciation with native speech and then provide the results are used.

However, most learning devices in which such programs are installed merely compare an input speech of a learner with native pronunciation for evaluation and provide the results to the learner as a score through the programs.

Also, a learner can largely know how accurate his or her pronunciation is from the provided score. However, because there are no means for separately comparing vowel/consonant pronunciation, stress, and intonation, it is not possible to accurately recognize how different his or her own vowel/consonant pronunciation, stress, and intonation are from native speech and which part of his or her speech is incorrect.

Therefore, correction of pronunciation is inefficiently performed, and it is difficult to induce a learner to correctly pronounce English. For this reason, there are limitations on the correction of faulty pronunciation, and considerable effort and investment are required to correct English pronunciation.

Even when a waveform of speech of a learner is analyzed in comparison with a waveform of speech of a native speaker of a second language which will be learned, it is difficult to accurately synchronize the two waveforms with respect to vocalization and articulatory time points through the comparison between the two waveforms, and elements of a supra segmental aspect of speech such as prosodic changes in intensity and pitch of each speech waveform have influence on the implementation of a speech signal. Therefore, only when there is no difference in such elements of a supra segmental aspect of speech between a speech signal of a learner and a speech signal of a native speaker for comparison, it is possible to accurately conduct a comparative analysis. Therefore, to accurately evaluate a difference in a segmental aspect of speech between pronunciation of a native speaker of a second language and pronunciation of a learner during such an actual comparative analysis of a speech waveform, a speech file of the native speaker for comparison and a speech file of the learner should have similar average peak values, similar playback times, similar fundamental frequencies (F0) based on the total frequency of vocal cords, which are vocal organs, per second.

In the case of speech recognition or a comparative analysis of a speech waveform, various distortion factors may be generated during a digital signal processing process for recording and analyzing a speech of a leaner to be compared with an original speech recorded in advance. A value of a speech signal may vary according to a signal-to-noise ratio (SNR) during speech recording, distortion caused by intensity overload, a compression ratio dependent on signal intensity for preventing such distortion caused by overload, a change in the speech signal dependent on a compression start threshold setting value of speech signal intensity during recording of the speech signal, and a sampling frequency rate and a quantization bit coefficient set during conversion into a digital signal. Therefore, when the specified signal processing methods used in a process of recording and digitizing two speech sources to be compared differ from each other, it may be difficult to conduct a comparative analysis and evaluate an accurate difference.

For this reason, bottom-up processing in which a learner understands and applies a change in sound according to stress and coarticulation to words while fully aware of accurate standard pronunciations of respective phonetic signs (phonemes) and learns and extensively applies various rules of prolonged sound, intonation, and rhythm to sentences, rather than top-down processing in which a learner understands principles of phoneme pronunciation at utterance levels of a word, a sentence, a paragraph, etc. whose change in pronunciation is influenced by various elements, such as stress, rhythm, prolonged sound, intonation, fluency, etc., is considered as a more effective learning method. Accordingly, learning accurate pronunciation at a phoneme level, that is, learning respective phonetic signs, of a particular language is becoming more important.

Pronunciation learning tools and devices of existing phonemic units simply generates and shows an image of a front view of facial muscles shown outside a person's body and the tongue seen in the oral cavity from the outside. Even an image obtained by simulating actual movement of articulators and vocal organs in the oral cavity and the nasal cavity merely shows changes in the position and movement of the tongue and has limitations in helping to imitate and learn pronunciation of a native speaker through the position and principle of a resonance for vocalization, a change in air current made during pronunciation, and so on.

Consequently, when a particular pronunciation is made in the oral cavity, it is necessary to facilitate a learner's understanding of pronunciation by showing the movement of all articulators, the flow of an air current, a place of articulation, and a resonance point, which are not seen from the outside of the body, and showing positions where articulation, vocalization, and a resonance occur at various angles.

### DISCLOSURE

### Technical Problem

The present invention is directed to solving the aforementioned problems, and a pronunciation-learning support system according to an embodiment of the present invention may be included in a predetermined user terminal device or server. When an image sensor which is included in or operates in conjunction with the pronunciation-learning support system recognizes the eye direction of a user who is using the pronunciation-learning support system or a direction of the user's face, an image processing device included in or operating in conjunction with the pronunciation-learning support system performs an image processing task to provide a pronunciation learning-related image seen in a first see-through direction determined with reference to the recognized direction. In this way, it is possible to implement a user interface for convenience of a user in which the user can be conveniently provided with professional data for language learning through images obtained at various angles.

The pronunciation-learning support system may manage a database (DB) which is included in or accessible by the pronunciation-learning support system. In the DB, at least a part of recommended air current information data including strength and direction information of an air current flowing through the inner space of an oral cavity during vocalization of a pronunciation corresponding to each pronunciation subject and recommended resonance point information data including information on a position on an articulator where a resonance occurs during the vocalization of the corresponding pronunciation may be recorded. The pronunciation-learning support system acquires at least a part of the recommended air current information data and the recommended resonance point information data recorded in the DB from the DB under a predetermined condition and provides the acquired information data by displaying the acquired information data in an image through the image processing device, thereby supporting the user of the pronunciation-learning support system in the learning of pronunciations of various languages very systematically and professionally with convenience.

The pronunciation-learning support system may acquire vocalization information according to the pronunciation subjects from a plurality of subjects and conduct or support a frequency analysis of the vocalization information acquired according to the pronunciation subjects. To conduct such a frequency analysis, the pronunciation-learning support system may include or operate in conjunction with a frequency analysis device which is an audio sensor, and the frequency analysis device can extract two lowest frequencies F1 and F2 from formant frequencies. By acquiring the recommended resonance point information data according to pieces of the vocalization information with reference to the extracted frequencies F1 and F2 and recording the acquired data in the DB, it is possible to support the user of the pronunciation-learning support system in viewing and listening to very reasonable and accurate vocalization information according to the pronunciation subjects.

To detect the user's vocalization of a particular pronunciation subject, the pronunciation-learning support system may include or operate in conjunction with an audio sensor, and acquire the user's actual resonance point information data of the particular pronunciation subject using the audio sensor. When displaying the actual resonance point information data at the corresponding position on an articulator in an image provided based on the first see-through direction, the pronunciation-learning support system operates the image processing device so that particular recommended resonance point information data recorded in the DB can be visibly displayed at the corresponding position on the articulator in the image provided based on the first see-through direction. In this way, the pronunciation-learning support system can support the user in immediately and conveniently comparing the actual resonance point information of his or her pronunciation and the recommended resonance point information recorded in the DB.

The image processing device may refer to metadata so that at least some of articulators are processed as different layers, and the metadata is included in and managed by the image processing device or can be acquired from a predetermined DB and consulted. Therefore, the user of the pronunciation-learning support system can activate only an articulator used to pronounce a particular pronunciation subject that he or she vocalizes and include the articulator in an image, thereby increasing his or her interest in and the effects of the language learning.

The present invention is also directed to solving the aforementioned problems, and a pronunciation-learning support system according to another embodiment of the present invention may be included in a predetermined user terminal device or server. An image processing device included in or operating in conjunction with the pronunciation-learning support system provides an image by performing (i) a process of providing preparatory oral cavity image information by displaying information on a state of an inner space of an oral cavity and states of articulators included in particular preparatory data corresponding to a particular pronunciation subject, (ii) a process of providing vocalizing oral cavity image information by displaying at least a part of particular recommended air current information data and particular recommended resonance point information data corresponding to the particular pronunciation subject in the inner space of the oral cavity and at least some positions on the articulators, and (iii) a process of providing follow-up oral cavity image information by displaying information on the state of the inner space of the oral cavity and states of the articulators included in particular follow-up data corresponding to the particular pronunciation subject, thereby supporting a user in learning a correct pronunciation through a preparatory process, a main process, and a follow-up process for the particular pronunciation subject.

To (i) acquire at least a part of preparatory data including information on a state of the inner space of the oral cavity and states of articulators before a vocalization of each of pronunciation subjects, (ii) acquire at least a part of recommended air current information data including strength and direction information of an air current flowing through the inner space of the oral cavity during the vocalization of the corresponding pronunciation and recommended resonance point information data including information on a position on an articulator where a resonance occurs during the vocalization of the corresponding pronunciation, and (iii) acquire at least a part of follow-up data including information on the state of the inner space of the oral cavity and states of the articulator after the vocalization of the corresponding pronunciation subject, the pronunciation-learning support system may include or operate in conjunction with an audio sensor for calculating ranges in which a resonance may occur during vocalization of a vowel in the oral cavity according to language, sex, and age. The audio sensor may calculate an average of the calculated ranges in which the resonance may occur. A predetermined section is set with reference to the calculated average so that the image processing device can generate a vowel quadrilateral based on information on the section, include the vowel quadrilateral in an image, and provide the image. In this way, the user can be provided with an accurate position where the resonance occurs, that is, accurate professional information for language learning.

The pronunciation-learning support system can acquire vocalization information according to the pronunciation subjects from a plurality of subjects and conduct or support a frequency analysis of the vocalization information acquired according to the pronunciation subjects. To conduct such a frequency analysis, the pronunciation-learning support system may include or operate in conjunction with a frequency analysis device which is an audio sensor, and the frequency analysis device can extract two lowest frequencies F1 and F2 from formant frequencies. By acquiring the recommended resonance point information data according to pieces of the vocalization information with reference to the extracted frequencies F1 and F2 and recording the acquired data in a DB, it is possible to support the user of the pronunciation-learning support system in viewing and listening to very reasonable and accurate vocalization information according to the pronunciation subjects.

To detect the user's vocalization of a particular pronunciation subject, the pronunciation-learning support system may include or operate in conjunction with an audio sensor, and acquire the user's actual resonance point information data of the particular pronunciation subject using the audio sensor. When displaying the actual resonance point information data at the corresponding position on an articulator in an image, the pronunciation-learning support system operates the image processing device so that particular recommended resonance point information data recorded in the DB can be visibly displayed for comparison at the corresponding position on the articulator in the image. In this way, the pronunciation-learning support system can support the user in immediately and conveniently comparing the actual resonance point information of his or her pronunciation and the recommended resonance point information recorded in the DB.

The image processing device may refer to metadata so that at least some of articulators are processed as different layers, and the metadata is included in and managed by the image processing device or can be acquired from a predetermined DB and consulted. Therefore, the user of the pronunciation-learning support system can activate only an articulator used to pronounce a particular pronunciation subject that he or she vocalizes and include the articulator in an image, thereby increasing his or her own interest in and the effects of the language learning.

The present invention is also directed to solving the aforementioned problems, and a pronunciation-learning support system according to still another embodiment of the present invention may be included in a predetermined user terminal device or server. An image processing device included in or operating in conjunction with the pronunciation-learning support system provides an image by (i) performing at least one of a process of displaying first particular recommended air current information data corresponding to a particular target-language pronunciation subject in an inner space of an oral cavity and a process of displaying first particular recommended resonance point information data corresponding to the particular target-language pronunciation subject at a particular position on an articulator and (ii) performing at least one of a process of displaying second particular recommended air current information data corresponding to a particular reference-language pronunciation subject in the inner space of the oral cavity and a process of displaying second particular recommended resonance point information data corresponding to the particular reference-language pronunciation subject at a particular position on the articulator, so that a user can accurately learn a pronunciation of a foreign language through a vocalization comparison between a target language and a reference language.

The pronunciation-learning support system may acquire vocalization information according to pronunciation subjects from a plurality of subjects and conduct or support a frequency analysis of the vocalization information acquired according to the pronunciation subjects. To conduct such a frequency analysis, the pronunciation-learning support system may include or operate in conjunction with a frequency analysis device which is an audio sensor, and the frequency analysis device can extract two lowest frequencies F1 and F2 from formant frequencies. By acquiring the recommended resonance point information data according to pieces of the vocalization information with reference to the extracted frequencies F1 and F2 and recording the acquired data in a DB, it is possible to support the user of the pronunciation-learning support system in viewing and listening to very reasonable and accurate vocalization information according to the pronunciation subjects.

To detect the user's vocalization of a particular pronunciation subject, the pronunciation-learning support system may include or operate in conjunction with an audio sensor, and acquire the user's actual resonance point information data of the particular pronunciation subject using the audio sensor. When displaying the actual resonance point information data at the corresponding position on an articulator in an image provided based on a first see-through direction, the pronunciation-learning support system operates the image processing device so that particular recommended resonance point information data recorded in the DB can be visibly displayed for comparison at the corresponding position on the articulator in the image provided based on the first see-through direction. In this way, the pronunciation-learning support system can support the user in immediately and conveniently comparing the actual resonance point information of his or her pronunciation and the recommended resonance point information recorded in the DB.

The image processing device may refer to metadata so that at least some of articulators are processed as different layers, and the metadata is included in and managed by the image processing device or can be acquired from a predetermined DB and consulted. Therefore, the user of the pronunciation-learning support system can activate only an articulator used to pronounce a particular pronunciation subject that he or she vocalizes and include the articulator in an image, thereby increasing his or her own interest in and the effects of the language learning.

### Technical Solution

According to an aspect of the present invention, there is provided a method of processing information by a pronunciation-learning support system, the method including: (a) accessing a DB managed by the pronunciation-learning support system or an external DB and acquiring at least a part of recommended air current information data including information on a strength and a direction of an air current flowing through an inner space of an oral cavity during a vocalization of each of pronunciation subjects and recommended resonance point information data including information on a position on an articulator where a resonance occurs during the vocalization of the pronunciation subject; and (b) when a particular pronunciation subject is selected from among the pronunciation subjects, providing an image by performing at least one of a process of requesting an image processing device managed by the pronunciation-learning support system or an external image processing device to display particular recommended air current information data corresponding to the particular pronunciation subject in the inner space of the oral cavity in an image provided based on a first see-through direction and a process of requesting the image processing device or the external image processing device to display particular recommended resonance point information data corresponding to the particular pronunciation subject at a particular position on an articulator in the image provided based on the first see-through direction.

According to an embodiment of the present invention, (b) may include, when the pronunciation-learning support system identifies the particular pronunciation subject pronounced by a user, requesting an image processing device managed by the pronunciation-learning support system or an external image processing device to provide an image by performing at least one of the process of displaying the particular recommended air current information data corresponding to the particular pronunciation subject in the inner space of the oral cavity in the image provided based on the first see-through direction and the process of displaying the particular recommended resonance point information data corresponding to the particular pronunciation subject at the particular position on the articulator in the image provided based on the first see-through direction.

According to an embodiment of the present invention, when an image processing device managed by the pronunciation-learning support system or an external image processing device is requested to identify a direction in which a user of the pronunciation-learning support system looks at a screen as a first direction according to a technology for recognizing a gaze of a user or a technology for recognizing a face of a user, the first see-through direction may be determined with reference to the first direction.

According to an embodiment of the present invention, (b) may include, when it is identified that the direction in which the user looks at the screen has been changed to a second direction while the image is provided in the first see-through direction, providing the image processed based on the first see-through direction and an image processed based on a second see-through direction stored to correspond to the second direction.

According to an embodiment of the present invention, (a) may include requesting an audio sensor managed by the pronunciation-learning support system or an external audio sensor to (a1) acquire vocalization information according to the pronunciation subjects from a plurality of subjects; (a2) conduct a frequency analysis on the vocalization information acquired according to the pronunciation subjects; and (a3) acquire the recommended resonance point information data with reference to F1 and F2 which are two lowest frequencies among formant frequencies acquired through the frequency analysis.

According to an embodiment of the present invention, when a vocalization of a user of the pronunciation-learning support system for the particular pronunciation subject is detected through an audio sensor, etc., (b) may include: (b1) acquiring actual resonance point information data of the user for the particular pronunciation subject from the detected vocalization; and (b2) providing an image by separately displaying the particular recommended resonance point information data stored to correspond to the particular pronunciation subject and the actual resonance point information data at corresponding positions on the articulator in the image provided based on the first see-through direction.

According to an embodiment of the present invention, the articulator may be n in number, metadata for processing at least some of the articulators as different layers may be stored, and, when the particular pronunciation subject is selected by a user of the pronunciation-learning support system, an image may be provided by activating a layer corresponding to at least one particular articulator related to the particular pronunciation subject.

According to another aspect of the present invention, there is provided a method of processing information by a pronunciation-learning support system, the method performed by the pronunciation-learning support system accessing a DB managed by itself or an external DB and including: (a) (i) acquiring at least a part of preparatory data including information on a state of an inner space of an oral cavity and a state of an articulator before a vocalization of each of pronunciation subjects, (ii) acquiring at least a part of recommended air current information data including strength and direction information of an air current flowing through the inner space of the oral cavity during the vocalization of the pronunciation subject and recommended resonance point information data including information on a position on an articulator where a resonance occurs during the vocalization of the pronunciation subject, and (iii) acquiring at least a part of follow-up data including information on a state of the inner space of the oral cavity and a state of the articulator after the vocalization of the pronunciation subject; and (b) when a particular pronunciation subject is selected from among the pronunciation subjects, providing an image by performing (i) a process of providing preparatory oral cavity image information by displaying information on a state of the inner space of the oral cavity and a state of an articulator included in particular preparatory data corresponding to the particular pronunciation subject, (ii) a process of providing vocalizing oral cavity image information by displaying at least a part of particular recommended air current information data and particular recommended resonance point information data corresponding to the particular pronunciation subject in the inner space of the oral cavity and in at least some positions on the articulator, and (iii) a process of providing follow-up oral cavity image information by displaying information on a state of the inner space of the oral cavity and a state of the articulator included in particular follow-up data corresponding to the particular pronunciation subject.

According to another embodiment of the present invention, (a) may include additionally acquiring information on a vowel quadrilateral through a process performed by an audio sensor managed by the pronunciation-learning support system or an audio sensor operating in conjunction with the pronunciation-learning support system, the process including: (a1) calculating ranges in which a resonance may occur during pronunciation of a vowel in the oral cavity according to language, sex, and age; (a2) calculating an average of the calculated ranged in which a resonance may occur; and (a3) setting a section with reference to the calculated average, and (b) may include, when the vowel is included in the selected particular pronunciation subject, inserting a vowel quadrilateral corresponding to the particular pronunciation subject in at least some of the preparatory oral cavity image information, the vocalizing oral cavity image information, and the follow-up oral cavity image information to provide the vowel quadrilateral.

According to the other embodiment of the present invention, (a) may be performed using a frequency analysis device, such as an audio sensor, etc., and include: (a1) acquiring vocalization information according to the pronunciation subjects from a plurality of subjects; (a2) conducting a frequency analysis on the vocalization information acquired according to the pronunciation subjects; and (a3) acquiring the recommended resonance point information data with reference to F1 and F2 which are two lowest frequencies among formant frequencies acquired through the frequency analysis.

According to the other embodiment of the present invention, when a vocalization of a user of the pronunciation-learning support system for the particular pronunciation subject is detected by an audio sensor, etc., (b) may include: (b1) acquiring actual resonance point information data of the user for the particular pronunciation subject from the detected vocalization; and (b2) providing an image by performing a process of separately displaying the particular recommended resonance point information data stored to correspond to the particular pronunciation subject and the actual resonance point information data at corresponding positions on the articulator and providing the vocalizing oral cavity image information.

According to the other embodiment of the present invention, the articulators may be n in number, metadata for processing at least some of the articulators as different layers may be stored, and, when the particular pronunciation subject is selected by a user of the pronunciation-learning support system, an image may be provided by activating a layer corresponding to at least one particular articulator related to the particular pronunciation subject.

According to still another aspect of the present invention, there is provided a method of processing information by a pronunciation-learning support system, the method performed by the pronunciation-learning support system accessing a DB managed by itself or an external DB and including: (a) acquiring at least a part of recommended air current information data including on strength and direction information of air currents flowing through an inner space of an oral cavity during vocalizations of pronunciation subjects in target languages and pronunciation subjects in reference languages corresponding to the pronunciation subjects in the target languages and recommended resonance point information data including information on positions on articulators where a resonance occurs during the vocalizations of the pronunciation subjects; and (b) when a particular target language is selected from among the target languages, a particular reference language is selected from among the reference languages, a particular target-language pronunciation subject is selected from among pronunciation subjects in the target language, and a particular reference-language pronunciation subject is selected from among pronunciation subjects in the particular reference language, providing an image by (i) performing at least one of a process of displaying first particular recommended air current information data corresponding to the particular target-language pronunciation subject in the inner space of the oral cavity and a process of displaying first particular recommended resonance point information data corresponding to the particular target-language pronunciation subject at a particular position on an articulator and (ii) performing at least one of a process of displaying second particular recommended air current information data corresponding to the particular reference-language pronunciation subject in the inner space of the oral cavity and a process of displaying second particular recommended resonance point information data corresponding to the particular reference-language pronunciation subject at a particular position on the articulator.

According to still another embodiment of the present invention, (b) may include (b1) acquiring speech data from a vocalization of a user of the pronunciation-learning support system using an audio sensor; (b2) acquiring a type of the reference language by analyzing the acquired speech data; and (b3) supporting the selection by providing types of n target languages among at least one target languages corresponding to the acquired type of the reference language in order of most selected as a pair with the acquired type of the reference language by a plurality of subjects who have used the pronunciation-learning support system.

According to still another embodiment of the present invention, (b) may include: (b1) acquiring speech data from a vocalization of a user of the pronunciation-learning support system using an audio sensor; (b2) acquiring a type of the target language by analyzing the acquired speech data; and (b3) supporting the selection by providing types of n reference languages among at least one reference languages corresponding to the acquired type of the target language in order of most selected as a pair with the acquired type of the target language by a plurality of subjects who have used the pronunciation-learning support system.

According to still another embodiment of the present invention, (a) may include (a1) acquiring vocalization information according to the pronunciation subjects in the target languages and acquiring vocalization information according to the pronunciation subjects in the reference languages from a plurality of subjects; (a2) separately conducting frequency analyses on the vocalization information acquired according to the pronunciation subjects in the target languages and the vocalization information acquired according to the pronunciation subjects in the reference languages; and (a3) acquiring the recommended resonance point information data with reference to F1 and F2 which are two lowest frequencies among formant frequencies acquired through the frequency analyses according to the vocalization information of the target languages and the vocalization information of the reference languages.

According to still another embodiment of the present invention, when a vocalization of a user of the pronunciation-learning support system for a particular pronunciation subject is detected as a vocalization of the particular target language or the particular reference language, (b) may include: (b 1) acquiring actual resonance point information data of the user for the particular pronunciation subject from the detected vocalization; and (b2) providing an image by separately displaying at least one of first particular recommended resonance point information data and second particular recommended resonance point information data stored to correspond to the particular pronunciation subject and the actual resonance point information data at corresponding positions on the articulator.

According to still another embodiment of the present invention, the articulators may be n in number, metadata for processing at least some of the articulators as different layers may be stored, and, when the particular target-language pronunciation subject or the particular reference-language pronunciation subject is selected by a user of the pronunciation-learning support system, an image may be provided by activating a layer corresponding to at least one particular articulator related to the particular target-language pronunciation subject or the particular reference-language pronunciation subject.

### Advantageous Effects

As described above, when an image sensor included in or operating in conjunction with a pronunciation-learning support system according to an embodiment of the present invention recognizes an eye direction of a user who is using the pronunciation-learning support system or a direction of the user's face, the pronunciation-learning support system causes an image processing device included in or operating in conjunction with the pronunciation-learning support system to perform an image processing task and provide a pronunciation learning-related image seen in a first see-through direction determined with reference to the recognized direction. In this way, it is possible to implement a user interface for convenience of a user in which the user can be conveniently provided with professional data for language learning through images obtained at various angles.

The pronunciation-learning support system may manage a DB which is included in or accessible by the pronunciation-learning support system. In the DB, at least a part of recommended air current information data including strength and direction information of an air current flowing through the inner space of an oral cavity during vocalization of a pronunciation corresponding to each pronunciation subject and recommended resonance point information data including information on a position on an articulator where a resonance occurs during the vocalization of the corresponding pronunciation may be recorded. The pronunciation-learning support system acquires at least a part of the recommended air current information data and the recommended resonance point information data recorded in the DB from the DB under a predetermined condition and provides the acquired information data by displaying the acquired information data in an image through the image processing device, thereby supporting the user of the pronunciation-learning support system in the learning of pronunciations of various languages very systematically and professionally with convenience.

The pronunciation-learning support system may acquire vocalization information according to the pronunciation subjects from a plurality of subjects and conduct or support a frequency analysis of the vocalization information acquired according to the pronunciation subjects. To conduct such a frequency analysis, the pronunciation-learning support system may include or operate in conjunction with a frequency analysis device which is an audio sensor, and the frequency analysis device can extract two lowest frequencies F1 and F2 from formant frequencies. By acquiring the recommended resonance point information data according to pieces of the vocalization information with reference to the extracted frequencies F1 and F2 and recording the acquired data in the DB, it is possible to support the user of the pronunciation-learning support system in viewing and listening to very reasonable and accurate vocalization information according to the pronunciation subjects.

To detect the user's vocalization of a particular pronunciation subject, the pronunciation-learning support system may include or operate in conjunction with an audio sensor, and acquire the user's actual resonance point information data of the particular pronunciation subject using the audio sensor. When displaying the actual resonance point information data at the corresponding position on an articulator in an image provided based on the first see-through direction, the pronunciation-learning support system operates the image processing device so that particular recommended resonance point information data recorded in the DB can be visibly displayed at the corresponding position on the articulator in the image provided based on the first see-through direction. In this way, the pronunciation-learning support system can support the user in immediately and conveniently comparing the actual resonance point information of his or her pronunciation and the recommended resonance point information recorded in the DB.

The image processing device may refer to metadata so that at least some of articulators are processed as different layers, and the metadata is included in and managed by the image processing device or can be acquired from a predetermined DB and consulted. Therefore, the user of the pronunciation-learning support system can activate only an articulator used to pronounce a particular pronunciation subject that he or she vocalizes and include the articulator in an image, thereby increasing his or her own interest in and the effects of the language learning.

An image processing device included in or operating in conjunction with a pronunciation-learning support system according to another embodiment of the present invention provides an image by performing (i) a process of providing preparatory oral cavity image information by displaying information on a state of an inner space of an oral cavity and states of articulators included in particular preparatory data corresponding to a particular pronunciation subject, (ii) a process of providing vocalizing oral cavity image information by displaying at least a part of particular recommended air current information data and particular recommended resonance point information data corresponding to the particular pronunciation subject in the inner space of the oral cavity and at least some positions on the articulators, and (iii) a process of providing follow-up oral cavity image information by displaying information on the state of the inner space of the oral cavity and states of the articulators included in particular follow-up data corresponding to the particular pronunciation subject, thereby supporting a user in learning a correct pronunciation through a preparatory process, a main process, and a follow-up process for the particular pronunciation subject.

To (i) acquire at least a part of preparatory data including information on a state of the inner space of the oral cavity and states of articulators before a vocalization of each of pronunciation subjects, (ii) acquire at least a part of recommended air current information data including strength and direction information of an air current flowing through the inner space of the oral cavity during the vocalization of the corresponding pronunciation and recommended resonance point information data including information on a position on an articulator where a resonance occurs during the vocalization of the corresponding pronunciation, and (iii) acquire at least a part of follow-up data including information on the state of the inner space of the oral cavity and a state of the articulator after the vocalization of the corresponding pronunciation subject from a DB included in or accessible by the pronunciation-learning support system, the pronunciation-learning support system may include or operate in conjunction with an audio sensor for calculating ranges in which a resonance may occur during vocalization of a vowel in the oral cavity according to language, sex, and age. The audio sensor may calculate an average of the calculated ranges in which a resonance may occur. A predetermined section is set with reference to the calculated average so that the image processing device can generate a vowel quadrilateral based on information on the section, include the vowel quadrilateral in an image, and provide the image. In this way, the user can be provided with an accurate position where a resonance occurs, that is, accurate professional information for language learning.

The pronunciation-learning support system can acquire vocalization information according to the pronunciation subjects from a plurality of subjects and conduct or support a frequency analysis of the vocalization information acquired according to the pronunciation subjects. To conduct such a frequency analysis, the pronunciation-learning support system may include or operate in conjunction with a frequency analysis device which is an audio sensor, and the frequency analysis device can extract two lowest frequencies F1 and F2 from formant frequencies. By acquiring the recommended resonance point information data according to pieces of the vocalization information with reference to the extracted frequencies F1 and F2 and recording the acquired data in a DB, it is possible to support the user of the pronunciation-learning support system in viewing and listening to very reasonable and accurate vocalization information according to the pronunciation subjects.

To detect the user's vocalization of a particular pronunciation subject, the pronunciation-learning support system may include or operate in conjunction with an audio sensor, and acquire the user's actual resonance point information data of the particular pronunciation subject using the audio sensor. When displaying the actual resonance point information data at the corresponding position on an articulator in an image, the pronunciation-learning support system operates the image processing device so that particular recommended resonance point information data recorded in the DB can be visibly displayed for a comparison at the corresponding position on the articulator in the image. In this way, the pronunciation-learning support system can support the user in immediately and conveniently comparing the actual resonance point information of his or her pronunciation and the recommended resonance point information recorded in the DB.

The image processing device may refer to metadata so that at least some of articulators are processed as different layers, and the metadata is included in and managed by the image processing device or can be acquired from a predetermined DB and consulted. Therefore, the user of the pronunciation-learning support system can activate only an articulator used to pronounce a particular pronunciation subject that he or she vocalizes and include the articulator in an image, thereby increasing his or her own interest in and the effects of the language learning.

An image processing device included in or operating in conjunction with a pronunciation-learning support system according to still another embodiment of the present invention provides an image by (i) performing at least one of a process of displaying first particular recommended air current information data corresponding to a particular target-language pronunciation subject in an inner space of an oral cavity and a process of displaying first particular recommended resonance point information data corresponding to the particular target-language pronunciation subject at a particular position on an articulator and (ii) performing at least one of a process of displaying second particular recommended air current information data corresponding to a particular reference-language pronunciation subject in the inner space of the oral cavity and a process of displaying second particular recommended resonance point information data corresponding to the particular reference-language pronunciation subject at a particular position on the articulator, so that a user can accurately learn pronunciation of a foreign language through a vocalization comparison between a target language and a reference language.

The pronunciation-learning support system may acquire vocalization information according to pronunciation subjects from a plurality of subjects and conduct or support a frequency analysis of the vocalization information acquired according to the pronunciation subjects. To conduct such a frequency analysis, the pronunciation-learning support system may include or operate in conjunction with a frequency analysis device which is an audio sensor, and the frequency analysis device can extract two lowest frequencies F1 and F2 from formant frequencies. By acquiring the recommended resonance point information data according to pieces of the vocalization information with reference to the extracted frequencies F1 and F2 and recording the acquired data in a DB, it is possible to support the user of the pronunciation-learning support system in viewing and listening to very reasonable and accurate vocalization information according to the pronunciation subjects.

To detect the user's vocalization of a particular pronunciation subject, the pronunciation-learning support system may include or operate in conjunction with an audio sensor, and acquire the user's actual resonance point information data of the particular pronunciation subject using the audio sensor. When displaying the actual resonance point information data at the corresponding position on an articulator in an image provided based on a first see-through direction, the pronunciation-learning support system operates the image processing device so that particular recommended resonance point information data recorded in the DB can be visibly displayed for comparison at the corresponding position on the articulator in the image provided based on the first see-through direction. In this way, the pronunciation-learning support system can support the user in immediately and conveniently comparing the actual resonance point information of his or her pronunciation and the recommended resonance point information recorded in the DB.

The image processing device may refer to metadata so that at least some of articulators are processed as different layers, and the metadata is included in and managed by the image processing device or can be acquired from a predetermined DB and consulted. Therefore, the user of the pronunciation-learning support system can activate only an articulator used to pronounce a particular pronunciation subject that he or she vocalizes and include the articulator in an image, thereby increasing his or her own interest in and the effects of the language learning.

### DESCRIPTION OF DRAWINGS

FIG. 1 is a diagram showing a configuration of a pronunciation-learning support system according to an exemplary embodiment of the present invention.

FIG. 2 is a diagram showing a configuration of a pronunciation-learning support system according to another exemplary embodiment of the present invention.

FIG. 3 is a diagram showing a configuration of a pronunciation-learning support database (DB) unit of a pronunciation-learning support system according to an exemplary embodiment of the present invention.

FIG. 4 is a diagram showing a configuration of a three-dimensional (3D) image information processing module of a pronunciation-learning support system according to an exemplary embodiment of the present invention.

FIG. 5 is a flowchart illustrating an information processing method of the 3D image information processing module of the pronunciation-learning support system providing first and second 3D image information according to an exemplary embodiment of the present invention.

FIG. 6 is a flowchart illustrating an information processing method of the 3D image information processing module of the pronunciation-learning support system receiving control information and providing 3D image information corresponding to the control information according to an exemplary embodiment of the present invention.

FIG. 7 is a flowchart illustrating an information processing method of the 3D image information processing module of the pronunciation-learning support system receiving see-through direction selection information and providing 3D image information corresponding to the see-through direction according to an exemplary embodiment of the present invention.

FIG. 8 is a flowchart illustrating an information processing method of the 3D image information processing module of the pronunciation-learning support system receiving articulator-specific layer selection information and providing 3D image information corresponding to articulator-specific layers according to an exemplary embodiment of the present invention.

FIG. 9 is a flowchart illustrating an information processing method of the 3D image information processing module of the pronunciation-learning support system processing speech information received from a user according to an exemplary embodiment of the present invention.

FIGS. 10 to 12 are images included in first 3D image information provided regarding [p] based on a first see-through direction according to an exemplary embodiment of the present invention.

FIGS. 13 and 14 are diagrams of intermediate steps between provision of a first 3D image and provision of a second 3D image showing that a see-through direction continuously changes.

FIGS. 15 to 17 are images included in second 3D image information provided regarding [p] based on a second see-through direction according to an exemplary embodiment of the present invention.

FIGS. 18 to 20 are images included in other second 3D image information provided regarding [p] based on a third see-through direction according to an exemplary embodiment of the present invention.

FIGS. 21 to 23 are images included in still other second 3D image information provided regarding [p] based on a fourth see-through direction according to an exemplary embodiment of the present invention.

FIGS. 24 to 26 are images included in 3D image information integrally provided regarding [p] based on four see-through directions according to an exemplary embodiment of the present invention.

FIGS. 27 to 29 are images included in first 3D image information provided regarding a semivowel [w] based on a first see-through direction according to an exemplary embodiment of the present invention.

FIGS. 30 to 32 are images included in second 3D image information provided regarding a semivowel [w] based on a second see-through direction according to an exemplary embodiment of the present invention.

FIGS. 33 and 34 are diagrams showing information processing results of a 3D image information processing module of a pronunciation-learning support system in which resonance point information and recommended resonance point information are comparatively provided according to an exemplary embodiment of the present invention.

FIG. 35 is a diagram showing a configuration of an oral cavity image information processing module of the pronunciation-learning support system providing oral cavity image information according to an exemplary embodiment of the present invention.

FIG. 36 is a flowchart illustrating an information processing method of the oral cavity image information processing module of the pronunciation-learning support system providing oral cavity image information of a pronunciation subject according to an exemplary embodiment of the present invention.

FIG. 37 is a flowchart illustrating an information processing method of the oral cavity image information processing module of the pronunciation-learning support system providing oral cavity image information corresponding to control information for a received oral cavity image according to an exemplary embodiment of the present invention.

FIG. 38 is a flowchart illustrating an information processing method of the oral cavity image information processing module of the pronunciation-learning support system providing oral cavity image information corresponding to a received pronunciation-supporting visualization means according to an exemplary embodiment of the present invention.

FIG. 39 is a flowchart illustrating an information processing method of the oral cavity image information processing module of the pronunciation-learning support system providing oral cavity image information corresponding to received articulator-specific layer selection information according to an exemplary embodiment of the present invention.

FIG. 40 is a flowchart illustrating an information processing method of the oral cavity image information processing module of the pronunciation-learning support system processing speech information received from a user according to an exemplary embodiment of the present invention.

FIG. 41 is a diagram showing a result of preparatory oral cavity image information provided for a phoneme [ch] by the oral cavity image information processing module of the pronunciation-learning support system according to an exemplary embodiment of the present invention when provision of oral cavity image information of the fricative is requested.

FIGS. 42 to 45 are diagrams showing results of vocalizing oral cavity image information provided for a phoneme [ch] by the oral cavity image information processing module of the pronunciation-learning support system according to an exemplary embodiment of the present invention when provision of oral cavity image information of the fricative is requested.

FIG. 46 is a diagram showing a result of follow-up oral cavity image information provided for a phoneme [ch] by the oral cavity image information processing module of the pronunciation-learning support system according to an exemplary embodiment of the present invention when provision of oral cavity image information of the fricative is requested.

FIG. 47 is a diagram showing a result of preparatory oral cavity image information provided for a phoneme [ei] by the oral cavity image information processing module of the pronunciation-learning support system according to an exemplary embodiment of the present invention when provision of oral cavity image information of the phoneme is requested.

FIGS. 48 to 50 are diagrams showing results of vocalizing oral cavity image information provided for a phoneme [ei] by the oral cavity image information processing module of the pronunciation-learning support system according to an exemplary embodiment of the present invention when provision of oral cavity image information of the phoneme is requested.

FIG. 51 is a diagram showing a result of follow-up oral cavity image information provided for a phoneme [ei] by the oral cavity image information processing module of the pronunciation-learning support system according to an exemplary embodiment of the present invention when provision of oral cavity image information of the phoneme is requested.

FIG. 52 is an image of vocalizing oral cavity image information to which the spirit of the present invention is applied and in which vocal cord vibration image data 1481 indicating vibrations of vocal cords and a waveform image are additionally provided when there are vocal cord vibrations.

FIG. 53 is a diagram showing a result of processing preparatory oral cavity image information by the oral cavity image information processing module of the pronunciation-learning support system according to an exemplary embodiment of the present invention including a vowel quadrilateral.

FIG. 54 is a diagram showing a result of processing vocalizing oral cavity image information by the oral cavity image information processing module of the pronunciation-learning support system according to an exemplary embodiment of the present invention including a vowel quadrilateral.

FIG. 55 is a diagram showing a result of processing vocalizing oral cavity image information by the oral cavity image information processing module of the pronunciation-learning support system according to an exemplary embodiment of the present invention in which user vocalization resonance point information (a star shape) is displayed by receiving user vocalization information and processing F1 and F2 of the user vocalization information.

FIGS. 56 to 59 are diagrams showing results of processing vocalizing oral cavity image information by the oral cavity image information processing module of the pronunciation-learning support system according to an exemplary embodiment of the present invention in which vocalizing oral cavity image information reflects a muscle tension display means.

FIG. 60 is a diagram showing a configuration of a mapping pronunciation-learning support module of the pronunciation-learning support system supporting the learning of a pronunciation of a target language in comparison with pronunciation of a reference language according to an exemplary embodiment of the present invention.

FIG. 61 is a flowchart illustrating an information processing method of the mapping pronunciation-learning support module of the pronunciation-learning support system supporting the learning of a pronunciation of a target language in comparison with a pronunciation of a reference language according to an exemplary embodiment of the present invention.

FIG. 62 is a flowchart illustrating an information processing method of the mapping pronunciation-learning support module of the pronunciation-learning support system inquiring about pronunciation subject information of a target language mapped to received pronunciation subject information of a reference language according to an exemplary embodiment of the present invention.

FIG. 63 is a flowchart illustrating an information processing method of the mapping pronunciation-learning support module of the pronunciation-learning support system providing oral cavity image information corresponding to a reference language pronunciation, oral cavity image information corresponding to a target language pronunciation, and target-reference comparison information with reference to control information according to an exemplary embodiment of the present invention.

FIG. 64 is a flowchart illustrating an information processing method of the mapping pronunciation-learning support module of the pronunciation-learning support system providing user-target-reference comparison image information including user-target-reference comparison information according to an exemplary embodiment of the present invention.

FIG. 65 is a diagram showing a result of information processing by an inter-language mapping processing module of the pronunciation-learning support system according to an exemplary embodiment of the present invention in which reference language pronunciation-corresponding oral cavity image information of a reference language pronunciation subject [ [symbol] ] corresponding to [i] in a target language is displayed.

FIG. 66 is a diagram showing a result of information processing by the inter-language mapping processing module of the pronunciation-learning support system according to an exemplary embodiment of the present invention in which oral cavity image information corresponding to a target-language pronunciation subject [i] and oral cavity image information corresponding to a reference language pronunciation subject [ [symbol] ] are displayed together.

FIG. 67 is a diagram showing a result of information processing by the inter-language mapping processing module of the pronunciation-learning support system according to an exemplary embodiment of the present invention in which reference language pronunciation-corresponding oral cavity image information of a reference language pronunciation subject [ [symbol] ] corresponding to [ [symbol] ] and [:] in a target language is displayed.

FIG. 68 is a diagram showing a result of information processing by the inter-language mapping processing module of the pronunciation-learning support system according to an exemplary embodiment of the present invention in which oral cavity image information corresponding to a target-language pronunciation subject [ [symbol] ] and oral cavity image information corresponding to a reference language pronunciation subject [ [symbol] ] corresponding to the target-language pronunciation subject [ [symbol] ] are displayed together.

FIG. 69 is a diagram showing a result of information processing by the inter-language mapping processing module of the pronunciation-learning support system according to an exemplary embodiment of the present invention in which oral cavity image information corresponding to target-language pronunciation subjects [ [symbol] ] and [:] and oral cavity image information corresponding to a reference language pronunciation subject [ [symbol] ] corresponding to the target-language pronunciation subjects [ [symbol] ] and [:] are displayed together.

FIGS. 70 to 73 are diagrams showing a result of information processing by the inter-language mapping processing module of the pronunciation-learning support system according to an exemplary embodiment of the present invention to which the spirit of the present invention regarding consonants is applied.

### MODES OF THE INVENTION

Hereinafter, exemplary embodiments of the present invention will be described in detail with reference to the accompanying drawings.

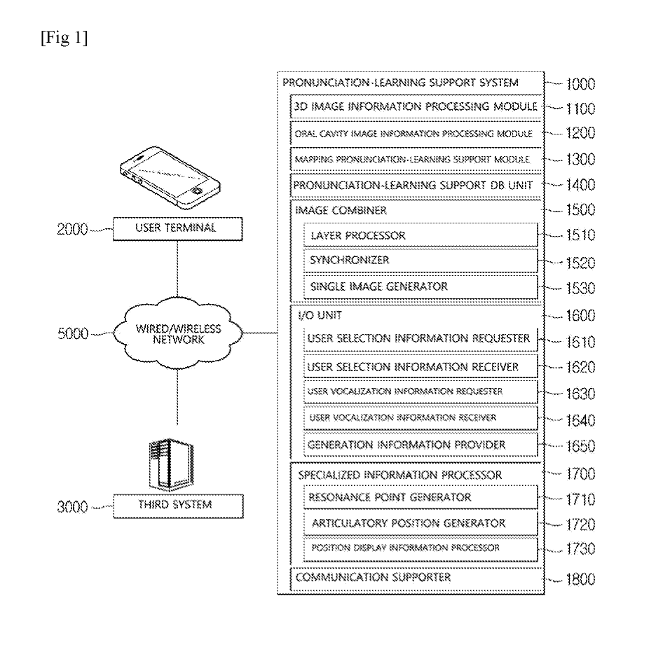

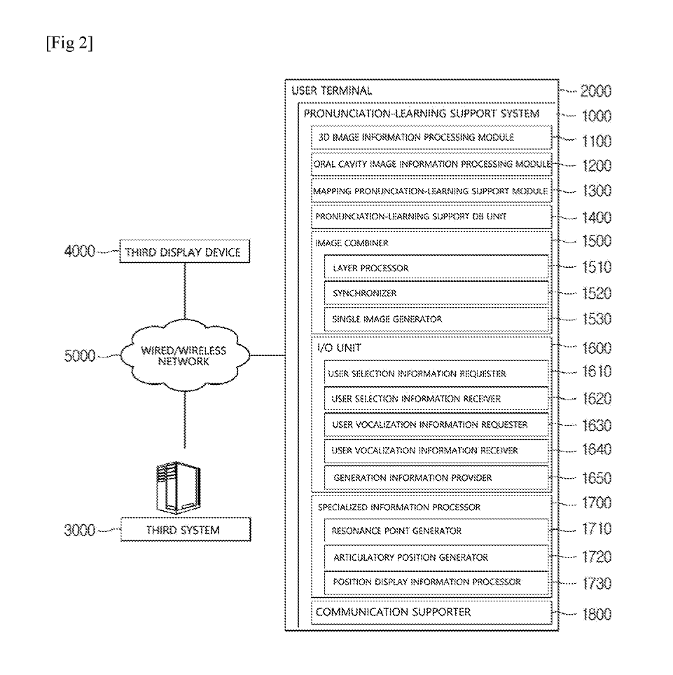

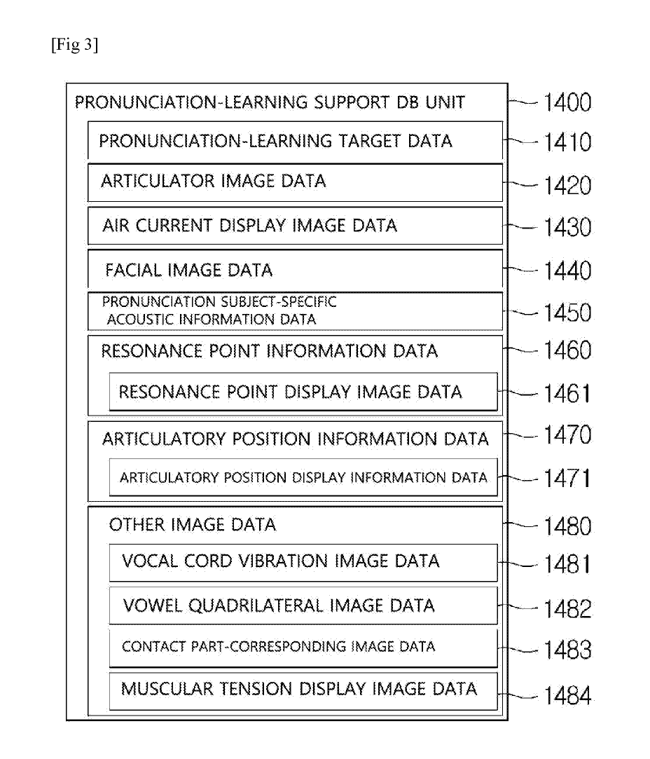

As shown in FIG. 1, a pronunciation-learning support system 1000 of the present invention may support a user in pronunciation learning by exchanging information with at least one user terminal 2000 through a wired/wireless network 5000. From the viewpoint of the pronunciation-learning support system 1000, the user terminal 2000 is a target which exchanges services with functions of the pronunciation-learning support system 1000. In the present invention, the user terminal 2000 does not preclude any of a personal computer (PC), a smart phone, a portable computer, a personal terminal, and even a third system. The third system may receive information from the pronunciation-learning support system 1000 of the present invention and transmit the received information to a terminal of a person who is provided with a service of the pronunciation-learning support system 1000. A dedicated program or particular software may be installed on the user terminal 2000, and the dedicated program or the particular software may implement the spirit of the present invention by exchanging information with the pronunciation-learning support system 1000. As shown in FIG. 2, the pronunciation-learning support system 1000 may also be run in the user terminal 2000. The pronunciation-learning support system 1000 may be run in a dedicated terminal for the pronunciation-learning support system 1000 or a dedicated program or particular software installed on the pronunciation-learning support system 1000. The dedicated program or the particular software may also be provided with a latest service or updated content from the pronunciation-learning support system 1000 through the wired/wireless network 5000.

The pronunciation-learning support system 1000 may include at least one of a three-dimensional (3D) image information processing module 1100 which processes 3D panoramic image information for pronunciation learning, an oral cavity image information processing module 1200 which processes oral cavity image information, a mapping pronunciation-learning support module 1300 which supports pronunciation learning using different languages. Meanwhile, the pronunciation-learning support system 1000 may include a pronunciation-learning support database (DB) unit 1400 including various DBs and data for supporting pronunciation learning. The pronunciation-learning support DB unit 1400 includes an input/output (I/O) unit 1600 which performs the function of exchanging information with the user terminal 2000 or the third system connected through the wired/wireless network 5000, a communication supporter 1800 in charge of a physical communication function, and also various other functional modules for general information processing with a server or a physical device for providing general computing functions. Also, the pronunciation-learning support system 1000 may include a connection unit which generates a combined image by combining unit images or images constituting an image and a specialized information processor 1700 which processes specialized information.

The 3D image information processing module 1100 may include a 3D image information DB 1110 including 3D image information data, a 3D image mapping processing module 1120 which processes 3D image mapping, a user input-based 3D image processor 1130 which processes user input-based 3D image information, and a panoramic image providing module 1140 which provides a panoramic image to the user terminal 2000 or a display device of the user terminal 2000. The 3D image information DB 1110 may include pronunciation subject-specific 3D image information data 1111, pronunciation subject-specific and see-through direction-specific 3D image information data 1112, and/or integrated 3D image information data 1113. The 3D image mapping processing module 1120 may include a 3D image mapping processor 1121 which processes mapping of pronunciation subject-specific 3D image information and pronunciation subject-specific 3D image mapping relationship information data 1122.

The oral cavity image information processing module 1200 may include an oral cavity image information DB 1210 which provides oral cavity image information, an oral cavity image providing module 1220 which provides oral cavity image information, a user input-based oral cavity image processor 1230 which receives an input of the user and processes oral cavity image information, and an oral cavity image information providing module 1240 which provides oral cavity image information. The oral cavity image information DB 1210 may include at least one of pronunciation subject-specific preparatory oral cavity image information data 1211, pronunciation subject-specific vocalizing oral cavity image information data 1212, pronunciation subject-specific follow-up oral cavity image information data 1213, and pronunciation subject-specific integrated oral cavity image information data 1214. The oral cavity image providing module 1220 may include at least one of an oral cavity image combiner/provider 1221 and an integrated oral cavity image provider 1222.

The mapping pronunciation-learning support module 1300 may include a mapping language image information DB 1310 which stores mapping language image information between different languages for pronunciation learning, an inter-language mapping processing module 1320 which performs a mapping function, a mapping language image information provision controller 1330 which controls provision of mapping language image information, and a user input-based mapping language image processor 1340 which processes mapping language image information based on information input by the user. The mapping language image information DB 1310 may include at least one of target language pronunciation-corresponding oral cavity image information data 1311, reference language pronunciation-corresponding oral cavity image information data 1312, target-reference comparison information data 1313, and integrated mapping language image information data 1314. The inter-language mapping processing module 1320 may include at least one of a plural language mapping processor 1321 which processes mapping information between a plurality of languages and pronunciation subject-specific inter-language mapping relationship information data 1322.

The pronunciation-learning support DB unit 1400 includes various kinds of data for supporting pronunciation learning according to the spirit of the present invention. The pronunciation-learning support DB unit 1400 may include at least one of pronunciation-learning target data 1410 storing pronunciation-learning targets, articulator image data 1420 storing images of articulators, air current display image data 1430 storing air current display images, facial image data 1440 storing facial image information, pronunciation subject-specific acoustic information data 1450 storing pronunciation subject-specific acoustic information, resonance point information data 1460 storing resonance point information, articulatory position information data 1470 storing articulatory position information, vocal cord vibration image data 1481 storing vocal cord vibration image information, vowel quadrilateral image data 1482 storing vowel quadrilateral image information, contact part-corresponding image data 1483 storing contact part-corresponding image information, and muscular tension display image data 1484 storing muscular tension display image data.

The pronunciation-learning target data 1410 includes information on phonemes, syllables, words, and word strings which are targets of pronunciation learning. The phonemes may include not only a phonetic alphabet related to a target language of pronunciation learning but also a phonetic alphabet related to a reference target language for pronunciation learning. Each syllable is formed of at least one of the phonemes, and the words or word strings may be prepared through linear combination of phonemes. Meanwhile, the phonemes and the syllables may correspond to spellings of the target language of pronunciation learning, and the corresponding spellings also constitute the pronunciation-learning target data 1410. Since the words and the word strings (phrases, clauses, and sentences) may correspond to spellings and the phonetic alphabets, the spellings and the corresponding phonetic alphabets or phonetic alphabet strings may also be important constituents of the pronunciation-learning target data 1410.

The articulator image data 1420 includes image data of articulators. There are largely three types of articulator images. A first type is articulator-specific image data for a particular pronunciation subject. Articulators include the tongue, lips, oral cavity, teeth, vocal cords, noise, etc., and at least one of the articulators may vary in shape (a visually recognized shape, tension, muscular movement, etc.) when a particular pronunciation is made. Here, the articulator-specific image data indicates time-series images (images like a video) in which movement of the articulator for the particular pronunciation occurs. Such articulator-specific image data is processed in layers according to the articulators, and layers may overlap for a particular pronunciation and be provided to the user. For articulator-specific enriched learning of correct pronunciation, the user may intend to intensively find out only movement of a particular articulator such as the tongue. At this time, only when articulator-specific layers have been provided, is it possible to provide only layers related to movement of the tongue, or to perform special processing (a clearly distinguishable color, a boundary, or other emphasizing) on the tongue alone, combine a layer subjected to the special processing with another layer, and provide the combined layers to the user terminal 2000. Layer-specific information processing is performed by a layer processor 1510 of an image combiner 1500 of the present invention. When layer processing is performed, synchronization with images of other articulators is important, and such synchronization is performed by a synchronizer 1520. Meanwhile, a single image (consisting of no layers or a single layer) may be generated through such special processing or combination of articulator-specific images, and the generation is performed by a single image generator 1530 of the present invention. Pronunciation subject-specific single images include images of all articulators for pronouncing the pronunciation subjects or essential or necessary articulators which are required to be visually provided. It is self-evident that one or more pieces of the articulator image data 1420 may be included for one articulator. In particular, this is more self-evident when a panoramic image which will be described below is provided as an image corresponding to a pronunciation subject. The articulator image data 1420 may be mapped to pronunciation subjects and stored.

The air current display image data 1430 includes images corresponding to a change in air current, such as flow, strength, compression, release, etc., made in articulators for pronunciation learning. The air current display image data 1430 may vary according to pronunciation subjects, and a particular piece of the air current display image data 1430 may be shared by pronunciation subjects. The air current display image data 1430 may be mapped to pronunciation subjects and stored.

The facial image data 1440 is required to provide facial images when pronunciations are made according to pronunciation subjects. The facial image data 1440 provides various changes, such as opening and closing of the oral cavity, movement of facial muscles, etc., occurring in the face while pronunciations are made, and thus is used to help with correct and efficient pronunciation learning. The facial image data 1440 can be separately provided during learning of a particular pronunciation, or may be provided subsidiary to, in parallel with, before, or after another image.

The pronunciation subject-specific acoustic information data 1450 is sound or vocalization data which is can be acoustically recognized according to pronunciation subjects. A plurality of sounds or vocalizations may be mapped to one pronunciation subject. Since a vocalization of a pronunciation subject may differently heard according to tone, sex, age, etc., it is preferable for a plurality of vocalizations to be mapped to one pronunciation subject so that the vocalizations can be heard friendly to the user. Here, the user may transmit selection information for characteristics (e.g., a female, before the break of voice, and a clear tone) that he or she wants to the pronunciation-learning support system 1000 (to this end, it is preferable for a user selection information requester 1610 of the pronunciation-learning support system 1000 to provide characteristic information of vocalizations which can be provided by the pronunciation-learning support system 1000 to the user terminal 2000), and the pronunciation-learning support system 1000 may proceed with pronunciation learning using vocalizations suited for the characteristics. At this time, synchronization is required between the vocalizations and images mapped to pronunciation subjects and performed by the synchronizer 1520. The vocalizations may also be present in combination with images mapped to the pronunciation subjects. Even in this case, if images mapped to the pronunciation subjects are generated according to available combinations of characteristics of selectable vocalizations, it is possible to provide a vocalization suited for characteristics selected by the user.

For a correct pronunciation of a pronunciation subject, it is important to cause a resonance (for vowels or some of semivowels/semiconsonants) at an accurate position. The resonance point information data 1460 of the present invention stores resonance point information of pronunciation subjects for which resonances occur. The resonance point information includes information on resonance point positions in articulators where resonances occur and resonance point display image data 1461 for visually recognizing resonance points. Since coordinates of a visually recognized position of a resonance point may vary according to oral cavity images, as the resonance point position information, absolute position information is secured according to oral cavity images, or relative position information is stored. Meanwhile, with the progress of pronunciation, the position of a resonance point may be changed (in the case of pronunciation of consecutive vowels or words). In this case, synchronization is required between the progress of pronunciation and a change in the position of a resonance point. When information on the position of a resonance point for each pronunciation subject is stored according to the lapse of vocalization time, the image combiner 1500 may perform the function of combining a change in the resonance point position information with an oral cavity image. A change in the resonance point position may also be processed on a separate layer for displaying a resonance point. In this case, layer processing is performed by the layer processor 1510 of the present invention, and synchronization is performed by the synchronizer 1520 of the present invention. Meanwhile, since a resonance may occur for a predetermined time or more while vocalization proceeds, when image information corresponding to a pronunciation subject is provided, it is preferable for a consistent resonance mark, for which the resonance point display image data 1461 is used, to be kept visually recognizable during a resonance. Also, a single image may be generated to include a resonance mark based on the resonance point display image data 1461 of pronunciation subjects for which a resonance occurs. While the single image generated through the user terminal 2000 is provided, the resonance point display image data 1461 may be visually recognized by the user.

At a time point or during a time period in which the amplitude of a resonance frequency in the oral cavity becomes as high as possible, that is, while a resonance occurs, due to vocal energy generated by vocalization at the vocal cords and passing through the oral cavity, a resonance display means may be displayed in images constituting a video. When the resonance display means which is the most important pronunciation-supporting visualization means is inserted and displayed, users can visually recognize the moment at which a resonance occurs in the oral cavities and the positions of their tongues in synchronization with a speech signal during playback of a video and the positions of their tongues during pronunciation of each phoneme. Therefore, a learner can recognize and estimate a vibrating portion of the tongue (position where a resonance occurs) as well as a position of the tongue in the oral cavity.

Sonorants are sounds produced by air flowing through the oral cavity or the nasal cavity. “Sonorants” is a relative term to “obstruents” and representatively refer to vowels, semivowels [w, j, etc.], liquid consonants [l, r, etc.], and nasals [m, n, ng] of each language. Among such sonorants, most sonorants other than semivowels (vowels, nasals, and liquid consonants) may constitute separate syllables (a minimum chunk of sound constituting a word having a meaning) in a word. Therefore, in language learning, incorrect pronunciations of such sonorants may cause recognition errors, such as distortion, assimilation, substitution, and omission of particular phonemes, and thus when a steady resonance occurs through accurate phonemic position adjustment of vocal organs and correct vocalization, it is possible to clearly deliver a meaning.

In the case of all vowels of each language, Korean “ [symbol] , [symbol] , [symbol] , [symbol] , [symbol] , [symbol] , [symbol] , [symbol] ,” English [w, j], French semivowels, and dark “l” (a pronunciation of l serving as a vowel, this can be used behind a vowel or a consonant like in “little” and form one separate syllable) among liquid consonants, a resonance point of formant frequencies F1 and F2 generally has such a steady value that a variable value of the position of the resonance point in the oral cavity calculated with a ratio of F1 to F2 can be accurately displayed and visually recognized by the learner. Also, since the position of the resonance point accurately corresponds to the surface of the tongue at a particular position during pronunciation of each phoneme, it is more effective to visually recognize this and imitate phonemic pronunciations of such sonorants with the learner's voice.

However, among these sonorants, sonorants, such as the nasals [m, n, ng] (whose resonance points are found using difference between areas and shapes of the nasal cavity as well as the oral cavity), light “l” (“l” separately present in front of a word without a vowel like in “lead” or forming one consonant cluster with a consonant like in “blade”) among liquid consonants, and [r], have a relatively short length of vocalized sound and thus it is difficult to visually check an accurate resonance point. Also, since the surface of the tongue at a fixed position on the tongue for the phonemic pronunciation of a particular sonorant does not correspond to the value of a resonance point of F1 and F2 at all frequently, such sonorants will be displayed not through resonance points but through articulatory positions, vocalizations, and pronunciation principles symbolized over time. In other words, it is preferable to display these sounds not with resonance points but through articulation processes like other consonants.

When two lowest frequencies among formant frequencies are F1 and F2, vowel pronunciation-specific resonance points are analyzed based on existing research papers in which a ratio of the two frequency values is analyzed, and the average of frequency bands where a resonance occurs on the surface of a particular position on the tongue in the oral cavity of a previously created 3D simulation image for estimating a position where a resonance occurs during pronunciation of each vowel according to languages is calculated. The average is synchronized to be displayed through a radiating sign from the playback start time of each vowel speech signal in a video and displayed at a position of the tongue where a resonance occurs in the oral cavity.

For a correct pronunciation of a pronunciation subject, it is important to generate a sound (for consonants or some of semivowels/semiconsonants) at an accurate articulatory position. The articulatory position information data 1470 of the present invention stores articulatory position information of pronunciation subjects. The articulatory position information includes information on articulatory positions in articulators and articulatory position display image data 1471 for visually recognizing articulatory positions. Since coordinates of a visually recognized position of an articulatory position may vary according to oral cavity images, as the articulatory position information, absolute position information is secured according to oral cavity images, or relative position information is stored. Meanwhile, with the progress of pronunciation, the articulatory position may be changed (in the case of pronunciation of consecutive vowels or words). In this case, synchronization is required between the progress of pronunciation and a change in the articulatory position. When articulatory position information for each pronunciation subject is stored according to the lapse of vocalization time, the image combiner 1500 may perform the function of combining a change in the articulatory position information with an oral cavity image. A change in the articulatory position may also be processed on a separate layer for displaying an articulatory position. In this case, layer processing is performed by the layer processor 1510 of the present invention, and synchronization is performed by the synchronizer 1520 of the present invention. Meanwhile, since the maintenance of or a change in an articulatory position may occur for a predetermined time or more while vocalization proceeds, when image information corresponding to a pronunciation subject is provided, it is preferable for a consistent articulatory position mark, for which the articulatory position display image data 1471 is used, to be kept visually recognizable at the articulatory position. Also, a single image may be generated to include an articulatory position mark for which the articulatory position display image data 1471 of pronunciation subjects is used. While the single image generated through the user terminal 2000 is provided, the articulatory position display image data 1471 may be visually recognized by the user.

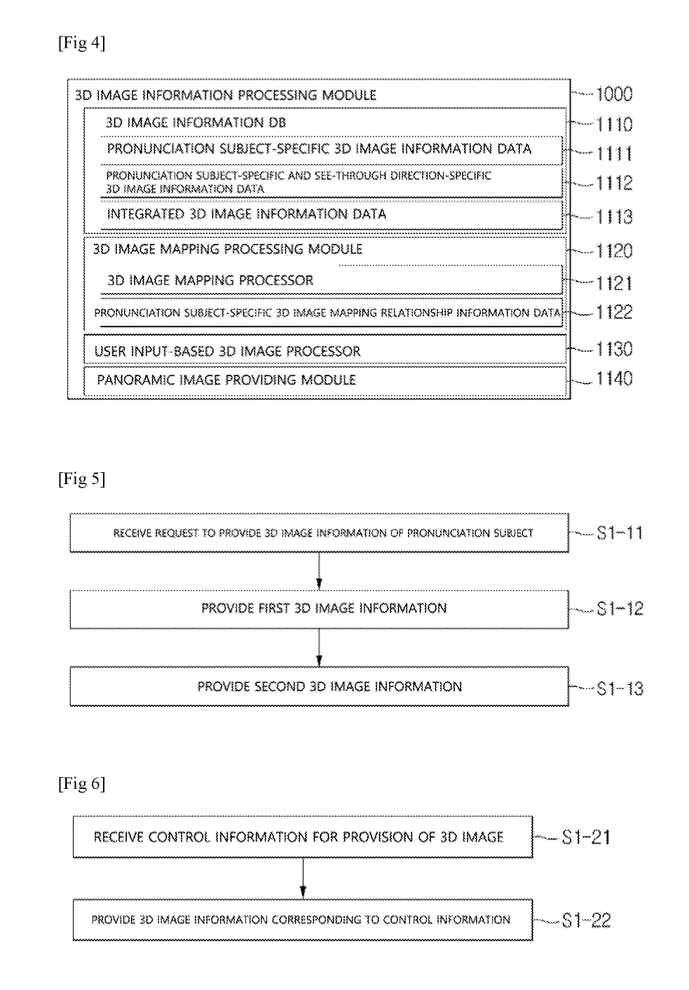

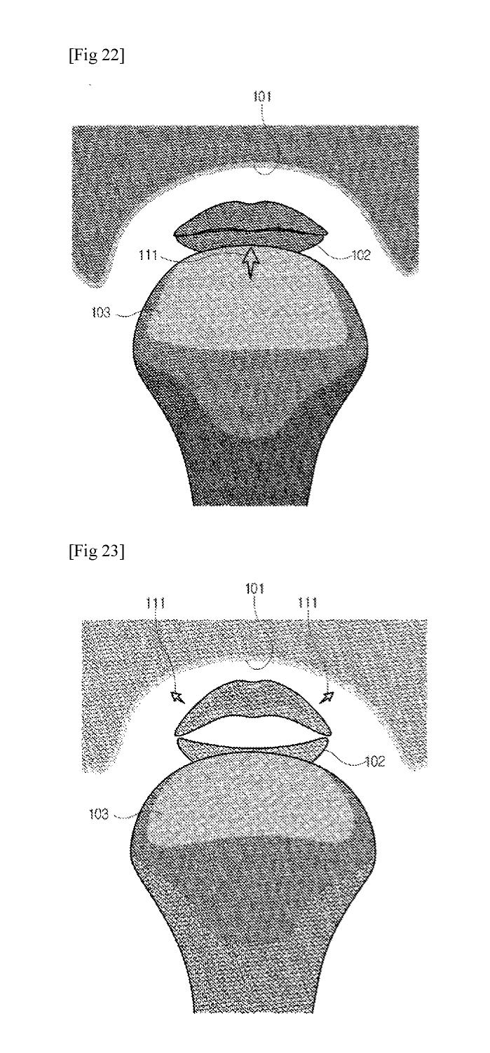

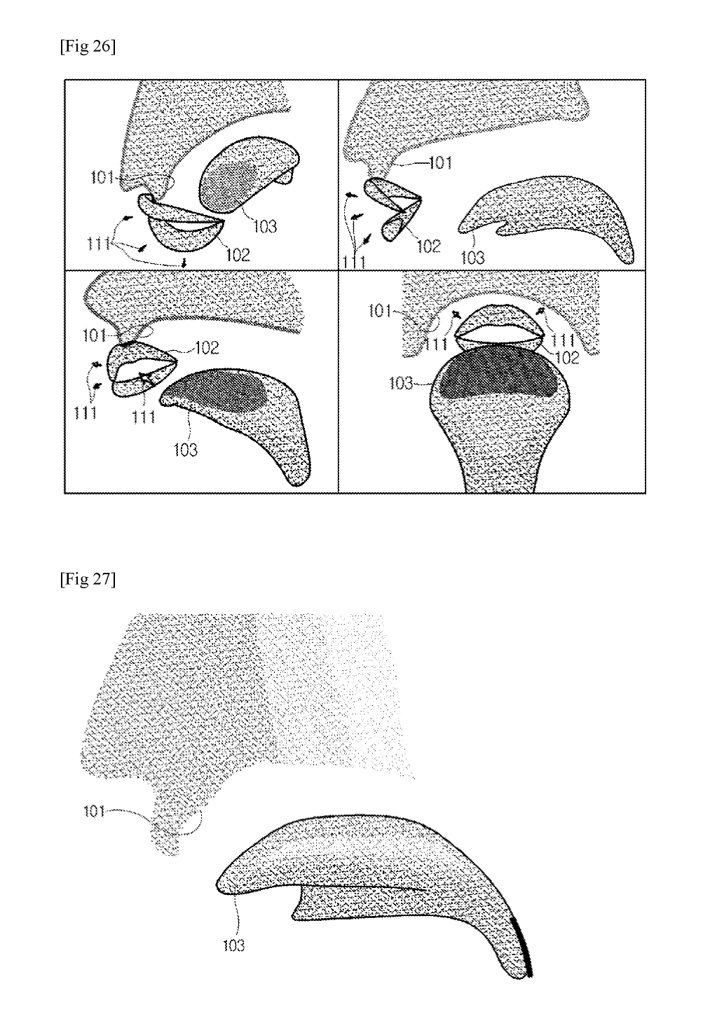

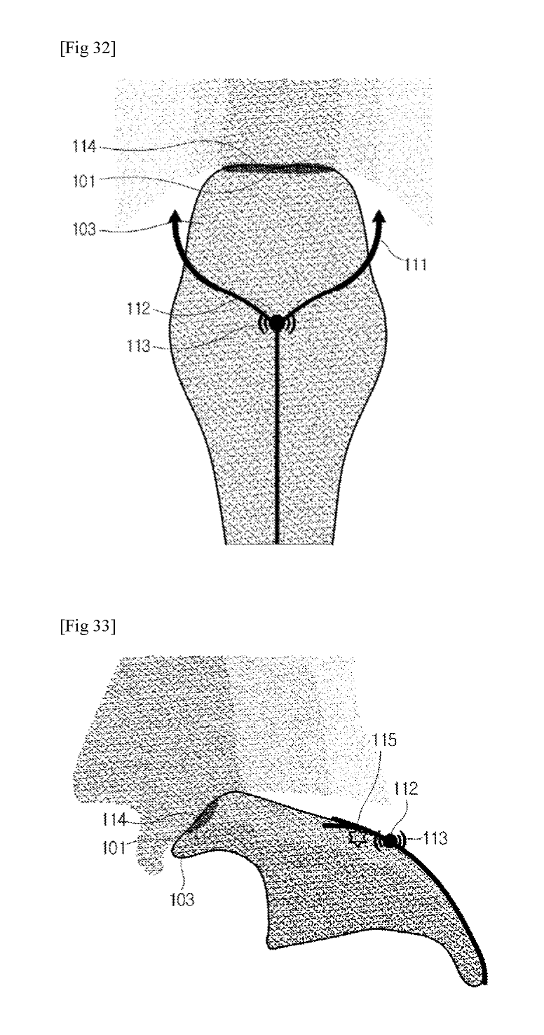

Subsequently, the 3D image information processing module 1100 and an information processing method of the 3D image information processing module 1100 will be described in further detail with reference to FIGS. 4 to 34.

As shown in FIG. 5, the 3D image information processing module 1100 performs the function of receiving a request to provide 3D image information of a pronunciation subject (S1-11), providing first 3D image information (S1-12), and providing at least one piece of second 3D image information (S1-13).

Both the first 3D image information and the second 3D image information correspond to dynamically changing images (e.g., videos; such changes include phased changes in units of predetermined time periods or a smooth and continuous change such as a video), and the videos include an articulatory mark, a resonance point mark or an articulatory position mark, an air current change mark, a vocal cord vibration mark, a contact part mark, etc. related to the pronunciation subject. All or some of these marks may be changed in visually recognizable forms, such as shapes, sizes, etc., while vocalization proceeds.

See-through directions (a direction in which an articulator is seen through, such as a viewpoint, an angle, etc.) differentiate the first 3D image information and the second 3D image information from each other. The first 3D image information provides 3D image information covering the preparation, start, and end of vocalization of one pronunciation subject based on one see-through direction. The see-through direction may be a plane angle, such as a front, back, left or right direction, but is preferably a solid angle (including up and down directions, examples of a solid angle may be a see-through angle from (1, 1, 1) in a 3D coordinate system toward the origin, a see-through angle from (1, 2/3, 1/3) toward the origin, etc.).

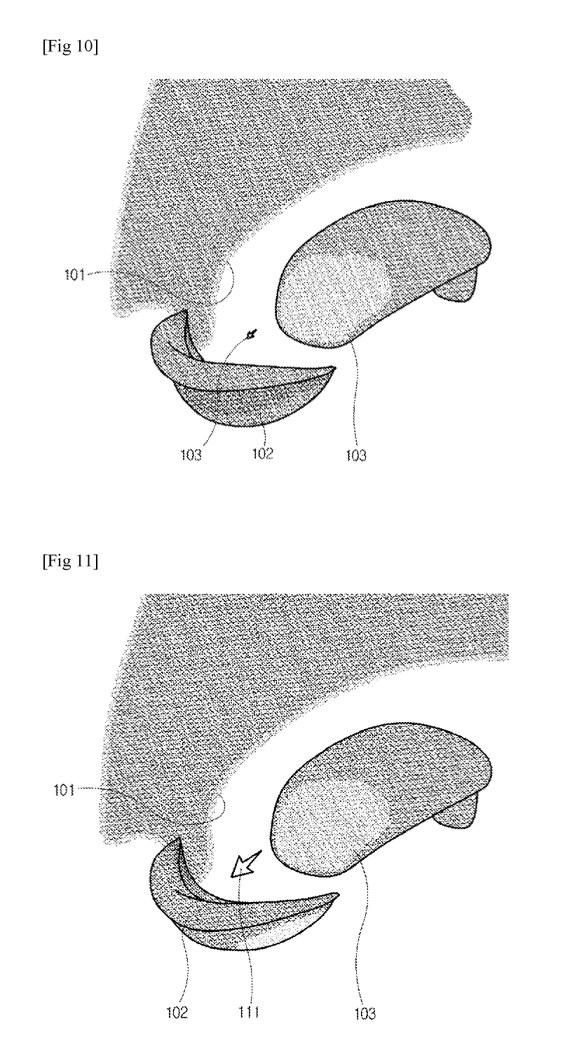

FIGS. 10 to 12 are images illustrating first 3D image information of the present invention provided regarding [p] at a particular first solid angle. It is preferable for the first 3D image information to be provided as a smooth video.

Due to limitations of description, the first 3D image information is expressed in stages in this specification, but may also be provided as a smooth and continuous change.

FIG. 10 is an image initially provided when the pronunciation [p] is about to start. As can be seen from FIG. 10, only the lips, the tongue, and the palate which are articulators used for the pronunciation [p] are displayed in three dimensions, and other irrelevant articulators are excluded. Also, it is possible to see a major characteristic of the present invention that inside images of articulators, such as the tongue and inner sides of the lips, are used. This cannot be achieved by displaying 2D images.

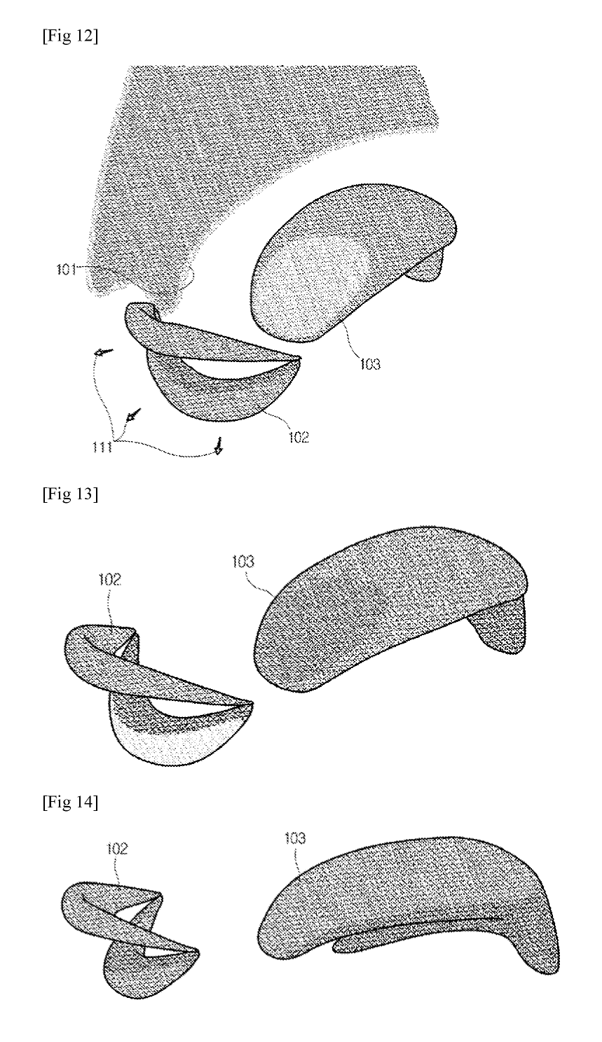

In FIG. 10, it is possible to see a small arrow between the tongue and the inner sides of the lips, and the small arrow is an image display means corresponding to a change in air current. It can be seen from FIG. 11 that an image display means corresponding to a change in air current is large in the same image. In FIG. 12, it is possible to see that the lips are opened and three small arrows radially directed from the lips are displayed as image display means corresponding to a change in air current. In this way, according to the present invention, images showing changes in air current are visually provided so that the user can intuitively recognize that it is necessary to gradually compress air and then emit the air radially upon opening the lips so as to correctly pronounce the plosive [p]. A simulation can be provided so that a change and the sameness during actual pronunciation can be visually recognized as much as possible through a change in the size of an arrow (a change in air pressure in the oral cavity) and a change in direction of an arrow (a change in air current) according to a change in air current over time during particular pronunciation.

Meanwhile, particularly using inside images of articulators, it is possible to know what kind of 3D shapes (the tip of the tongue is kept bent down, and the central portion of the tongue is kept flat) of the tongue and the lips are required to have so as to correctly vocalize the plosive [p].

FIGS. 13 and 14 are diagrams of intermediate steps between provision of a first 3D image and provision of a second 3D image showing that a see-through direction continuously changes.

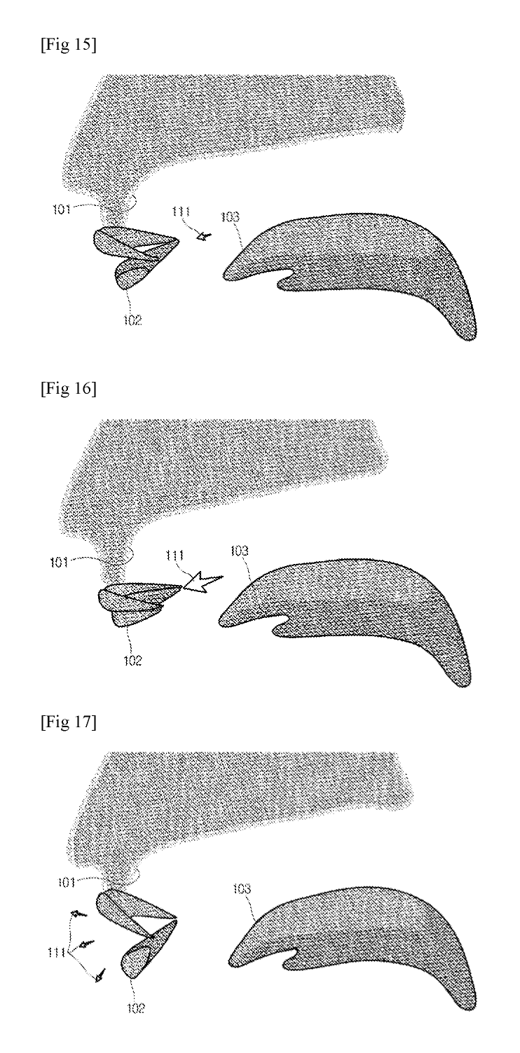

Next, FIGS. 15 to 17 show movement of articulators and the flow of or a change in air current for the pronunciation [p] in another see-through direction (a lateral direction). In particular, FIG. 16 shows that an air current display image 111 becomes as large as possible and the lips are firmly closed while there is no movement of the tongue. This indicates that air is compressed before the pronunciation [p] is burst out. This will be a good example showing effects of combination of 3D internal articulator images and the air current display image 111 for pronunciation learning according to the present invention.

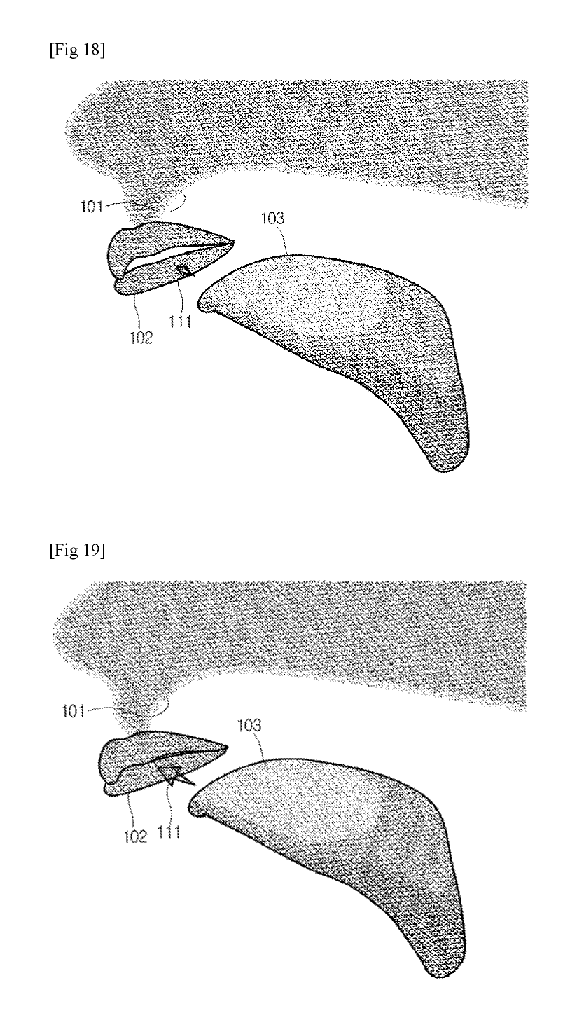

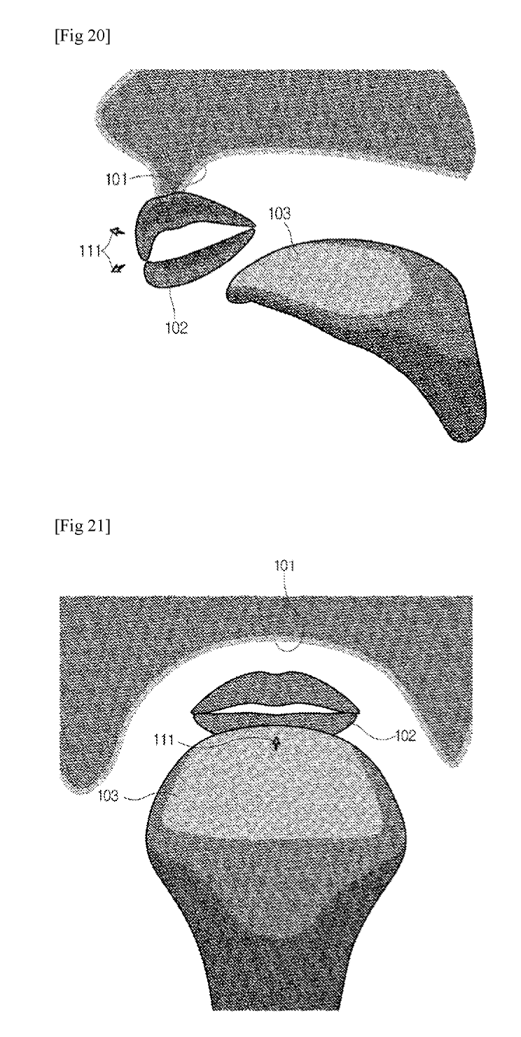

FIGS. 18 to 20 show movement of articulators and the flow of or a change in air current for the pronunciation [p] in still another see-through direction (another lateral direction crossing the direction of FIGS. 10 to 12 at right angles). In particular, FIGS. 19 and 20 do not show any image of an external articulator observed from the outside but show only 3D internal articulator images. This will be another good example showing effects of combination of 3D internal articulator images and the air current display image 111 according to the present invention. As shown in FIGS. 19 and 20, the present invention effectively shows a phenomenon which occurs or needs to occur to vocalize a particular pronunciation through 3D images and air current flow display images.

Lastly, FIGS. 21 to 23 show movement of articulators and the flow of or a change in air current for the pronunciation [p] in yet another see-through direction (a back-to-front direction).

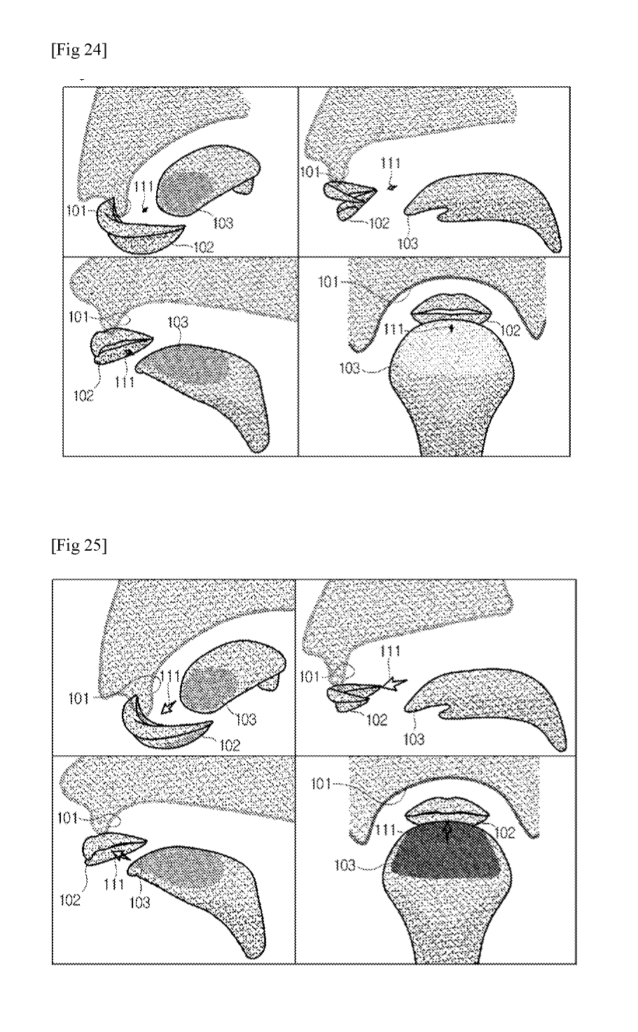

Meanwhile, the pronunciation-learning support system 1000 may bind n (n is a natural number greater than 1) images from a first 3D image to an n^{th} 3D image, which are selectively provided, to be shown in one screen and provide the n 3D images all together so that movement of articulators for the pronunciation [p] can be checked overall. In FIGS. 24 to 26, it is possible to check that n 3D images are provided all together.

To provide images of FIGS. 10 to 23 or FIGS. 10 to 26 in sequence, the pronunciation-learning support system 1000 may generate and store one integrated 3D image file in the integrated 3D image information data 1113 and then provide the integrated 3D image file to the user terminal 2000. Also, the 3D image information processing module 1100 may separately store n 3D images acquired in respective see-through directions as n image files and provide only 3D image information suited for the user's selection.

Further, as illustrated in FIGS. 6 to 8, the pronunciation-learning support system 1000 may generate 3D image information corresponding to a plurality of see-through directions, store the 3D image information in the pronunciation subject-specific and see-through direction-specific 3D image information data 1112, and then provide 3D image information corresponding to control information upon receiving the control information from the user terminal 2000. The 3D image information processing module 1100 may receive control information for provision of a 3D image (S1-21) and provide 3D image information corresponding to the control information (S1-22). The control information may be a see-through direction, a playback rate (normal speed, 1/n speed, nx speed, etc. (n is a natural number)), a selection of an articulator to be displayed or emphasized, a mark of a resonance point or an articulatory position, whether or not to display an air current or a display method of an air current, a pronunciation subject (a phoneme, a syllable, a word, and/or a word string), and so on. The user selection information requester 1610 of the I/O unit 1600 may provide a list of selectable control information to the user terminal 2000, receive control selection information of the user through a user selection information receiver 1620, and then receive and provide 3D image information corresponding to the control selection information of the user.

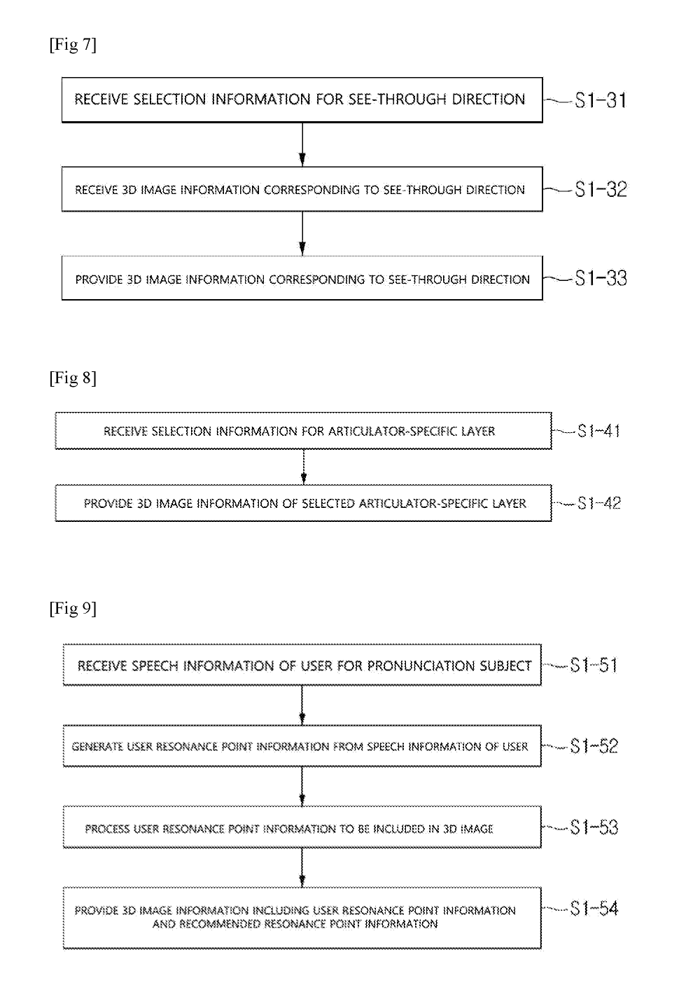

Representative control information may be a see-through direction, and such a case is illustrated in FIG. 7. As illustrated in FIG. 7, the 3D image information processing module 1100 may receive selection information for at least one see-through direction desired by the user from the user terminal 2000 (S1-31), receive 3D image information corresponding to the see-through direction (S1-32), and provide the 3D image information corresponding to the see-through direction (S1-33).

Meanwhile, when articulators are processed as different layers, as illustrated in FIG. 8, the 3D image information processing module 1100 may receive selection information for articulator-specific layers (S1-41) and provide 3D image information of the selected articulator-specific layers (S1-42).

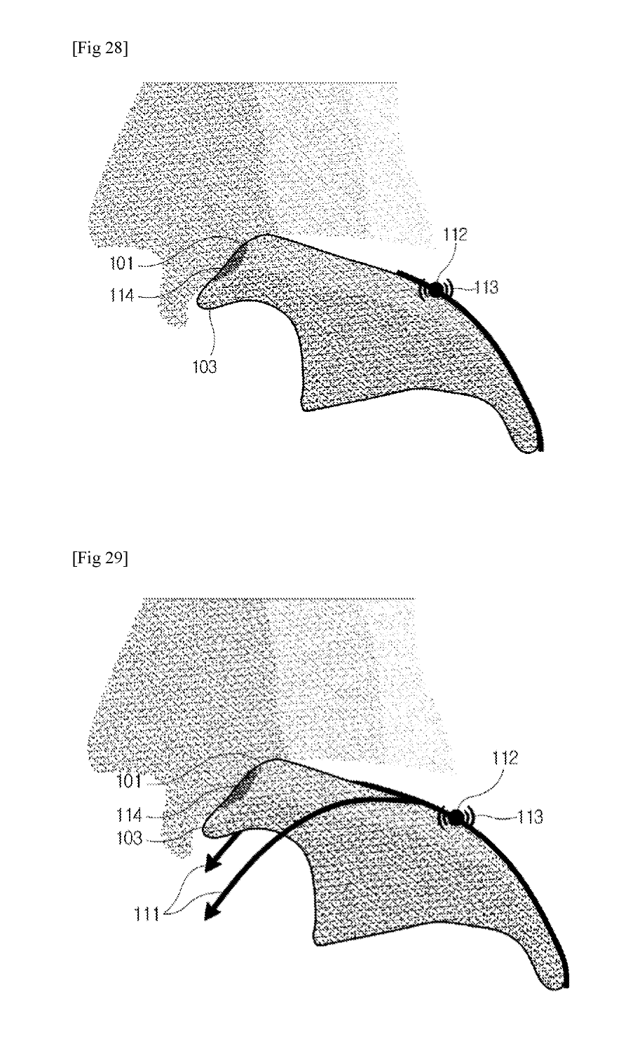

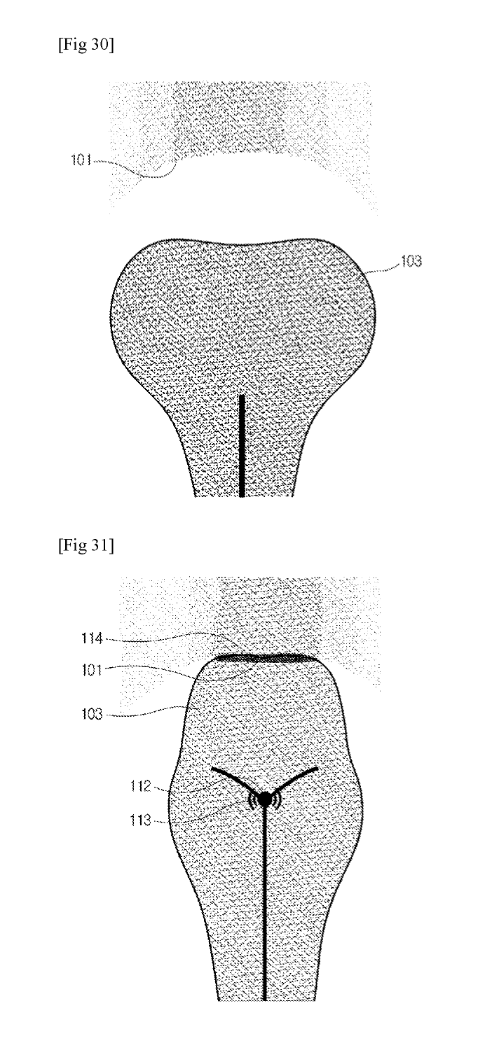

FIGS. 27 to 29 are diagrams related to first 3D image information of the semivowel [w], and FIGS. 30 to 32 are diagrams related to second 3D image information. In FIGS. 27 to 32, it is possible to see that there are marks of a resonance point, an air current, and a contact part. FIGS. 27 and 30 show that an air current goes up from the uvula to vocalize the semivowel, and FIGS. 28 and 31 show a resonance point at the center of the tongue and show that an air current mark branches to both sides via the periphery of the resonance point and the tip of the tongue is in contact with the palate. As can be seen from FIG. 28 and FIG. 31, a portion of the tongue (a palate contact portion display image 114) in contact with the palate is shaded (in a dark color; the shaded portion is the palate contact portion display image 114), unlike the remaining portion of the tongue, so that the user can intuitively understand that the tongue comes in contact with the palate for the pronunciation of the semivowel. Meanwhile, in FIGS. 28 and 29 and FIGS. 31 and 32, it is possible to see that a resonance point display image (the resonance point is shown as a circular dot, and there are radiating vibration marks around the resonance point) is maintained during the resonance. According to the spirit of the present invention, the resonance point display image and the air current display image 111 are supported so that the user can effectively learn maintenance of a resonance accurately synchronized with the progress of a vocalization.

The panoramic image providing module 1140 of the 3D image information processing module 1100 performs the function of providing 3D images, such as FIGS. 10 to 32, to the user terminal 2000 like a panorama while changing a see-through direction.

Meanwhile, the 3D image information processing module 1100 of the present invention may receive vocalization information for the same pronunciation subject from the user and derive position information of a resonance point from the received vocalization information. Derivation of resonance point position information of a vocalization input by a user is disclosed in Korean Patent Publication No. 10-2012-0040174 which is a prior art of the applicant for the present invention. The prior art shows that it is possible to conduct a frequency analysis on vocalization information of a user and determine (F2, F1) in which F1 is a y coordinate and F2 is an x coordinate as the position of a resonance point using F1 and F2 which are two lowest frequencies among formant frequencies.

When the position of a user (vocalizing) resonance point is determined based on user vocalization information, it is possible to generate comparative position information between the user (vocalizing) resonance point and a recommended resonance point for correct vocalization. As shown in FIG. 9, the 3D image information processing module 1100 performs a process of receiving speech/vocalization information of the user for a pronunciation subject (S1-51), generating user resonance point information (position information of a resonance point, resonance maintenance time information, etc.) from the speech/vocalization information of the user (S1-52), processing the user resonance point information to be included in a 3D image (S1-53), and providing 3D image information including user (vocalizing) resonance point information and recommended resonance point information (S1-54). Generation of resonance point information is performed by a resonance point generator 1710 of the present invention.

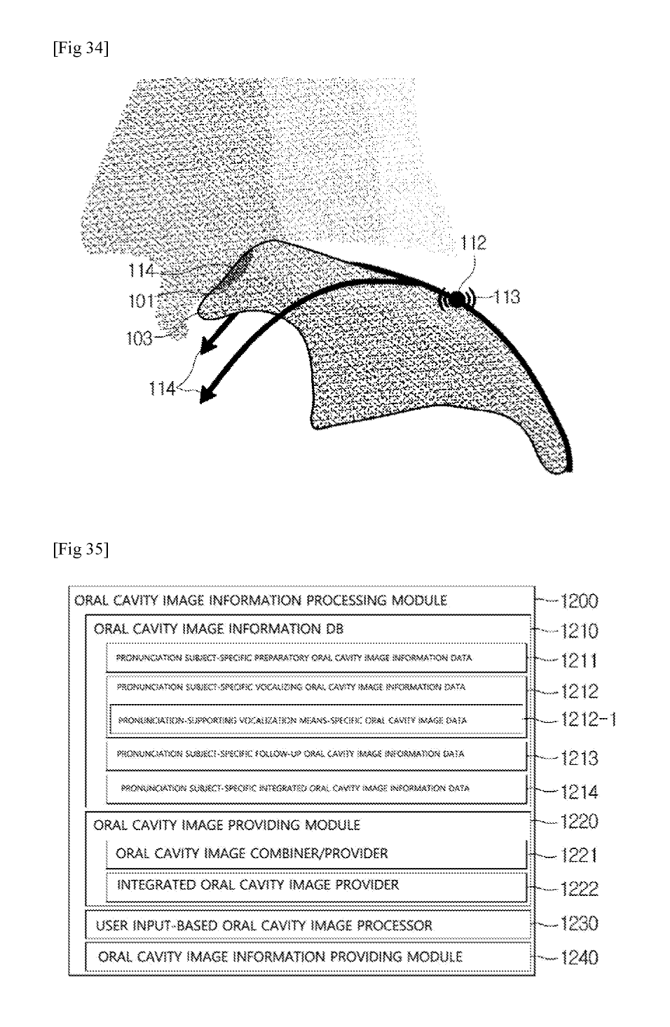

FIGS. 33 and 34 exemplify resonance point information and recommended resonance point information of the present invention in comparison with each other. In FIG. 33, it is possible to see that a star shape in a 3D image reflects resonance point information generated by the resonance point generator 1710. In FIG. 33, a user resonance point is shown to be located on the upper left side from the recommended resonance point, thereby helping the user in intuitively correcting pronunciation. Also, in FIG. 34, the user resonance point has disappeared, and only the recommended resonance point is maintained. FIG. 34 shows the user that the user resonance point is not consistently maintained, so that the user can intuitively grasp a learning point that a resonance maintenance time continues for a correct pronunciation.

FIG. 4 is a diagram showing a configuration of the 3D image information processing module 1100 according to an exemplary embodiment of the present invention. As can be seen from the above description, 3D image information data is included in the pronunciation subject-specific 3D image information data 1111 of the 3D image information DB 1110 according to pronunciation subjects, and includes 3D image information in all see-through directions. 3D image information included in the pronunciation subject-specific and see-through direction-specific 3D image information data 1112 includes separate 3D image information according to see-through directions. When selection information for a particular see-through direction is received from the user, the 3D image information included in the pronunciation subject-specific and see-through direction-specific 3D image information data 1112 is used. As 3D image information included in the integrated 3D image information data 1113, several 3D images are integrated with each other (integration according to see-through directions, integration according to tones, integration according to articulators, integration according to playback rates, etc.) and present according to pronunciation subjects.

The 3D image information processing module 1100 may receive selection information for a playback rate from the user and provide 3D images by adjusting the playback rate.

The 3D image mapping processing module 1120 manages 3D image information according to pronunciation subjects, and provides a piece of the pronunciation subject-specific 3D image mapping relationship information data 1122 when a request for a pronunciation subject (and a see-through direction) is received from the outside. Pieces of the pronunciation subject-specific 3D image mapping relationship information data 1122 may be as shown in Table 1 below.

TABLE 1

| Phoneme | See-through | | |
|---|---|---|---|
| Identifier | Direction | Filename | Others |
| Phoneme i | (1, 0, 0) | phoneme i_100.avi | Side |
| Phoneme i | (1, 1, 0) | phoneme i_110.avi | 45° right turn |
| Phoneme i | (0, 1, 0) | phoneme i_010.avi | Rear |
| Phoneme i | . . . | . . . | |
| Phoneme i | (1, 1, 1) | phoneme i_111.avi | Lower right |
| Phoneme i | Integrated | phoneme i.avi | Integrated all see- |
| | | | through directions |
| Phoneme j | (1, 0, 0) | phoneme j_100.avi | Side |
| | . . . | . . . | |

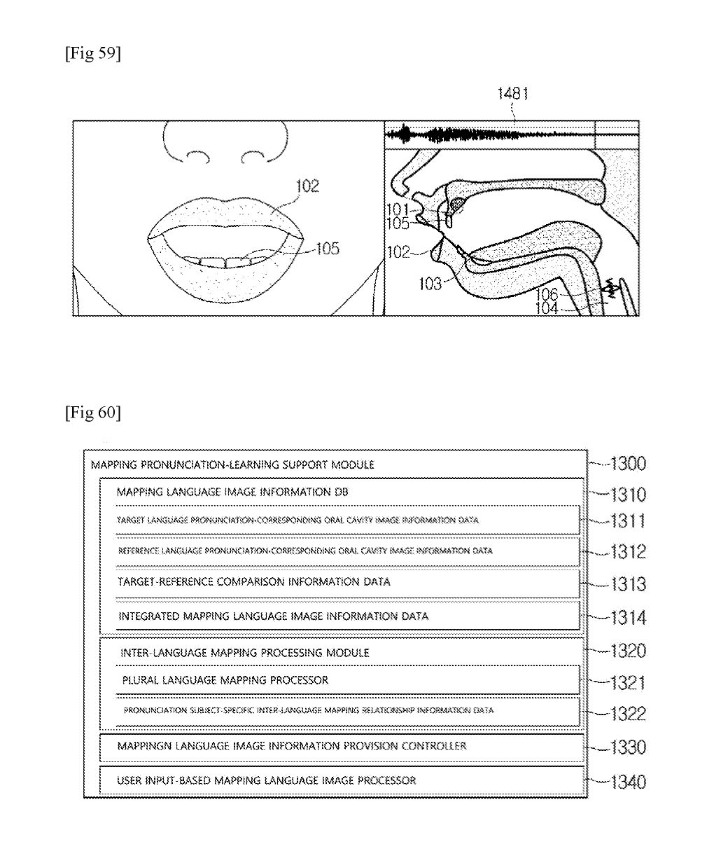

Next, an information processing method of the oral cavity image information processing module 1200 of the present invention will be described in further detail with reference to FIGS. 35 to 59.

When a request to provide oral cavity image information of a pronunciation subject is received (S2-11), the oral cavity image information processing module 1200 provides preparatory oral cavity image information (S2-12), and provides vocalizing oral cavity image information in succession (S2-13). Optionally, the oral cavity image information processing module 1200 may provide follow-up oral cavity image information (S2-14).

FIG. 41 shows an example image of a video provided for a phoneme [ch] as preparatory oral cavity image information when a request to provide oral cavity image information of the fricative is received from the user terminal 2000.

A cross-sectional image of articulators configured with three dimensions (major articulators, such as the tongue, etc., are shown as a 3D image having a 3D effect rather than a simple flat 2D image) is shown as a video constitution image which is preparatory oral cavity image information on the right side of FIG. 41, and a facial image is shown on the left side. In the present invention, the facial image on the left side may be optional. It is possible to know that a preparatory position of the tongue, preparation for air current generation at the vocal cords, and an articulatory position (a circle at a portion where the tongue is in contact with the palate indicates the articulatory position) are displayed in preparatory oral cavity image information shown in FIG. 41. In the preparatory oral cavity image information, a vocalization is prepared only and is not started actually. Accordingly, a vocalization which can be acoustically recognized does not correspond to the preparatory oral cavity image information. From the preparatory oral cavity image information shown in FIG. 41, the user can visually understand what kind of preparation is required to vocalize a pronunciation subject which involves pronunciation learning.

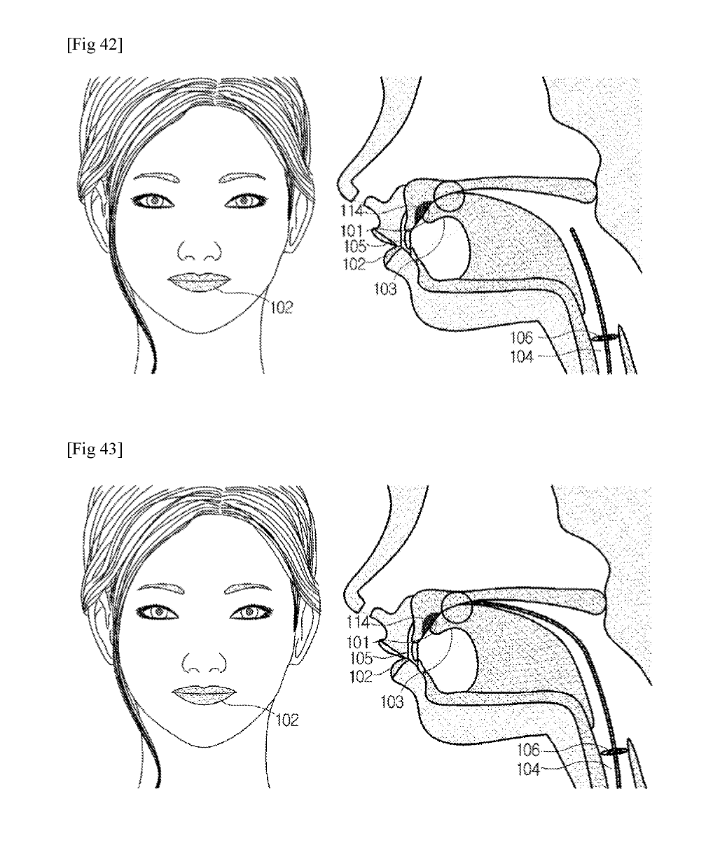

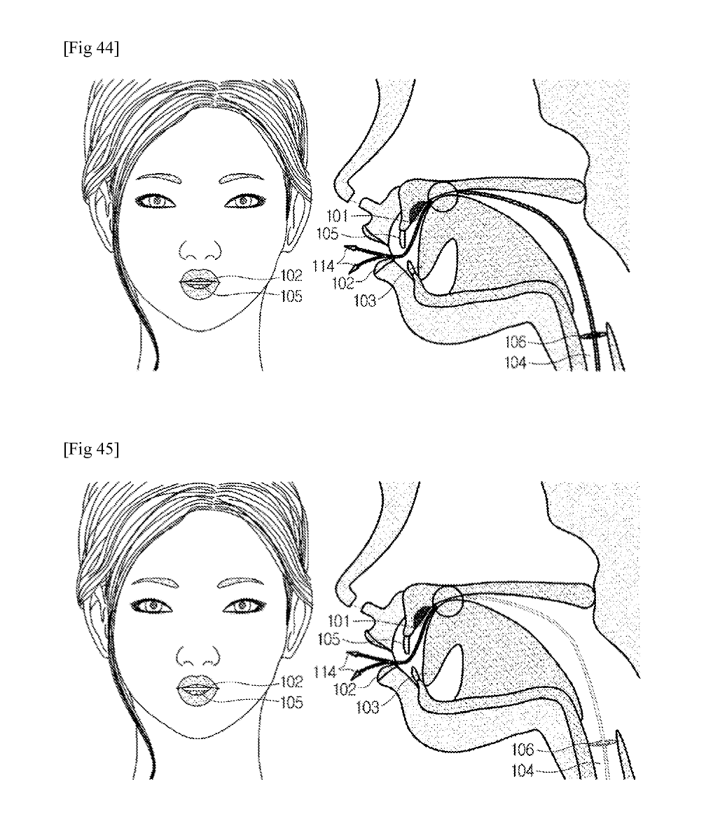

FIGS. 42 to 45 show images which are a part of a video constituting vocalizing oral cavity image information. As can be seen from FIGS. 42 to 45, vocalizing oral cavity image information includes various images, such as an air current display image, etc., shown when a vocalization is made. The user can see that an air stream is coming upward from the vocal cords through an image such as FIG. 42 included in the vocalizing oral cavity image information, and see through an image such as FIG. 43 that the contact between the tongue and the palate does not break out until the air current reaches the portion where the tongue is in contact with the palate. Also, the user can see through an image such as FIG. 44 that the tongue bends up to the center and the lips and the teeth are opened when the tongue and the palate are slightly separated from each other and the air current is emitted through the gap, and intuitively understand through FIG. 45 that the air current is gradually becoming extinct but there is no change in the shape of the tongue and the position where the tongue is in contact with the palate. In particular, the thickness of a color indicating the air current changes between FIGS. 44 and 45, and it is possible to reflect a change in the strength of the air current through a change in the thickness, chroma, etc. of the color.

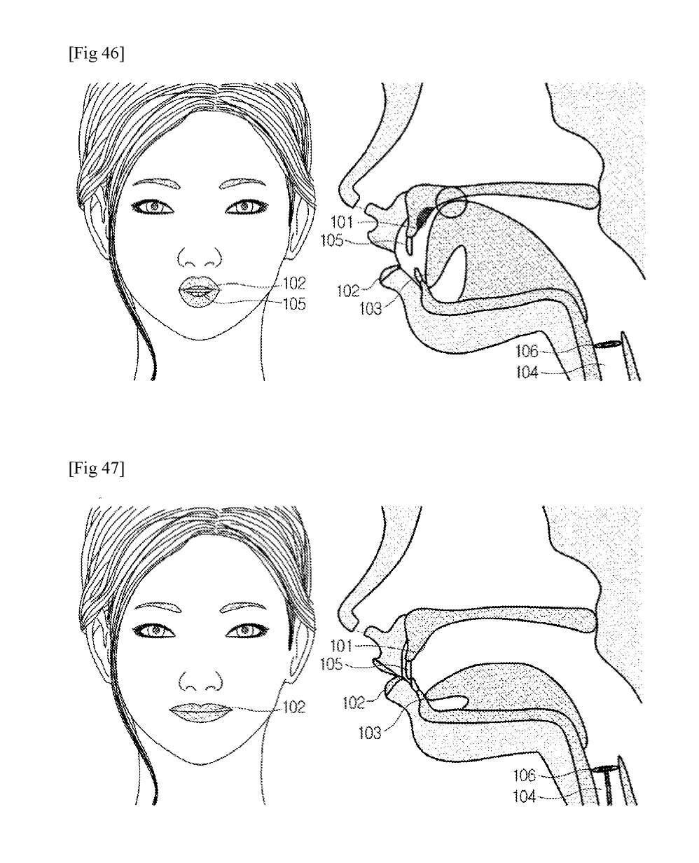

FIG. 46 shows an image included in a video corresponding to follow-up oral cavity image information according to an exemplary embodiment. As can be seen from FIG. 46 that the air current has become extinct, the teeth and the lips are open, and there is no change in the position where the tongue is in contact with the palate. By selectively providing follow-up oral cavity image information, it is possible to correctly complete the pronunciation. When the completion (end) is correctly maintained, the process just before the end can be accurately imitated, and thus provision of the follow-up oral cavity image information is an important part of the spirit of the present invention for accurate pronunciation learning.

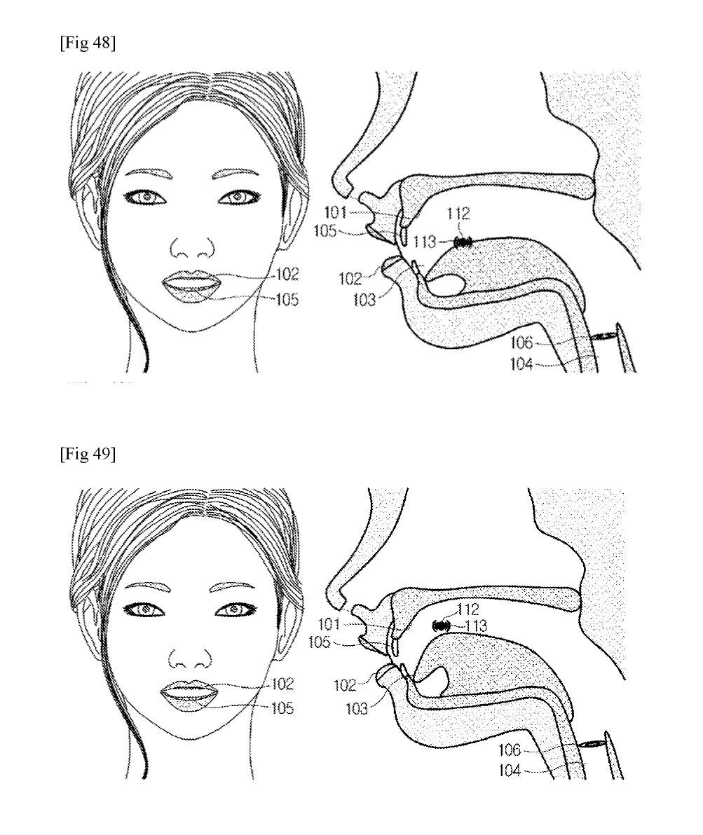

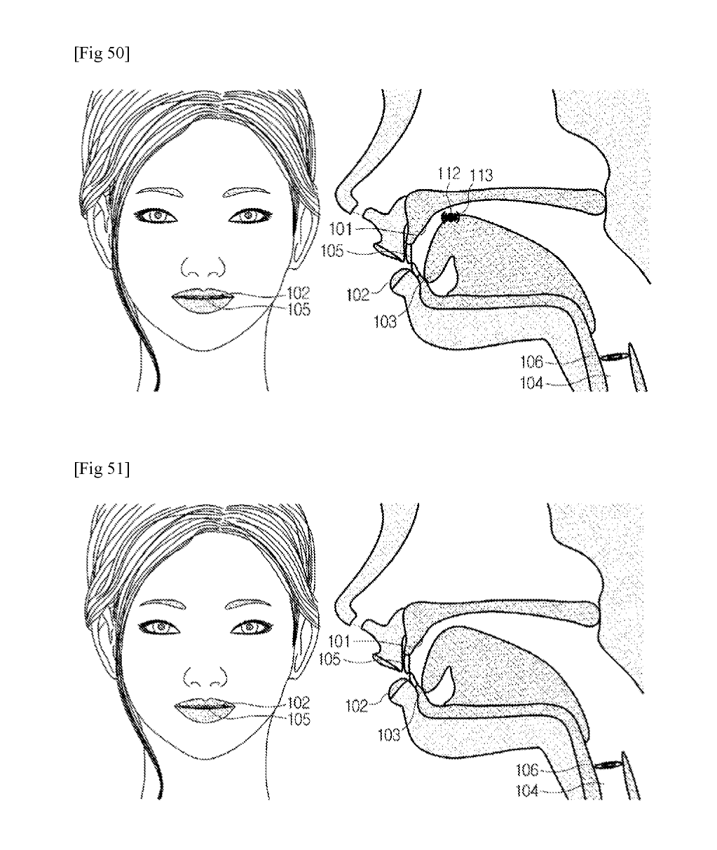

FIGS. 47 to 50 show a configuration of an exemplary embodiment for the pronunciation [ei] in which the spirit of the present invention is implemented. FIG. 47 is an image showing a configuration of preparatory oral cavity image information of the phoneme [ei] according to an exemplary embodiment. FIGS. 48 to 50 are example images showing a configuration of vocalizing oral cavity image information of the phoneme [ei] according to an exemplary embodiment. The user can see in FIG. 48 that the tongue is at a low position and a resonance point is on the tongue, and can see in FIG. 49 that a resonance point is in the space of the oral cavity apart from the tongue. In FIG. 50, the user can see that a resonance point is at a position on the tongue close to the palate, and can see that the resonance continues through vibration marks radiating to the left and right in a resonance display image 113. FIG. 51 is an image showing a configuration of follow-up oral cavity image information of the phoneme [ei] according to an exemplary embodiment. Through the follow-up oral cavity image information of FIG. 51 to which the spirit of the present invention is applied, the user can see that the resonance has become extinct and the position and the state of the tongue in the oral cavity are maintained the same as the final position and state of the vocalizing oral cavity image information.

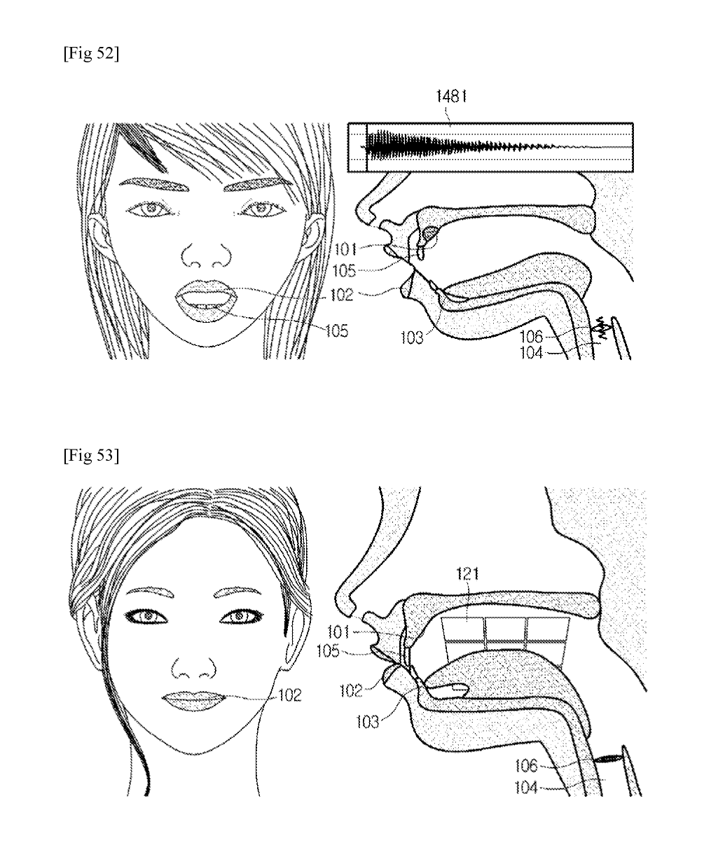

FIG. 52 is an image of vocalizing oral cavity image information to which the spirit of the present invention is applied and in which the vocal cord vibration image data 1481 indicating vibrations of the vocal cords is displayed when there are vocal cord vibrations. As can be seen from FIG. 52, when there are vocal cord vibrations, a waveform image related to the vocal cord vibrations may be additionally provided. Whether or not there are vocal cord vibrations may be marked at the position of the vocal cords in an image. Specifically, there is no mark for an unvoiced sound, and in the case of a voiced sound, for example, a zigzag mark representing vocalization may be inserted only at a time point when vocalization in a speech signal of a video occurs at the vocal cords.

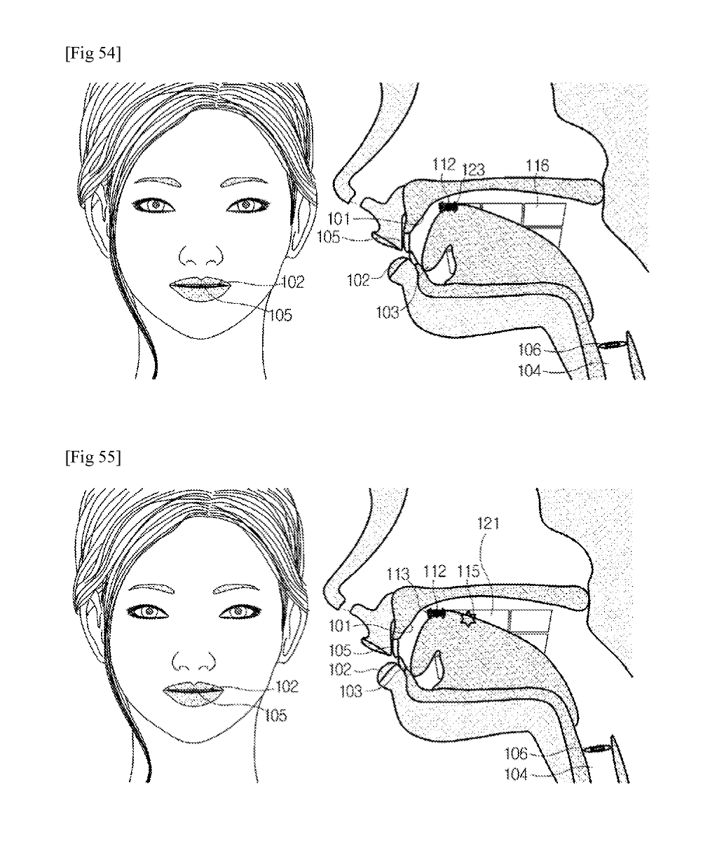

FIG. 53 is an image of preparatory oral cavity image information including a vowel quadrilateral image 121 according to an exemplary embodiment of the present invention, and FIG. 54 is an image of vocalizing oral cavity image information including the vowel quadrilateral image 121 according to an exemplary embodiment of the present invention. When a trapezoidal vowel quadrilateral (a range limit in which resonances for all vowels of a particular language can occur in the oral cavity) set by calculating an average of a range in which a resonance can occur in the oral cavity, in the event of a vowel pronunciation by each of an adult male, an adult female, and a child before the break of voice for each language, is inserted into the oral cavity image, it is possible to facilitate the learner's understanding when he or she pronounces a vowel and estimates a position at which the tongue vibrates in the oral cavity. In images of the present invention, vowel quadrilaterals are trapezoids shown in grey.

FIG. 35 is a diagram showing a configuration of the oral cavity image information processing module 1200 according to an exemplary embodiment of the present invention. According to pronunciation subject, the pronunciation subject-specific preparatory oral cavity image information data 1211 stores preparatory oral cavity image information data, the pronunciation subject-specific vocalizing oral cavity image information data 1212 stores vocalizing oral cavity image information, and the pronunciation subject-specific follow-up oral cavity image information data 1213 stores follow-up oral cavity image information. When the preparatory oral cavity image information, the vocalizing oral cavity image information, and the follow-up oral cavity image information exist as one integrated digital file, the pronunciation subject-specific integrated oral cavity image information data 1214 stores the integrated digital file according to pronunciation subjects.

The vocalizing oral cavity image information stored in the pronunciation subject-specific vocalizing oral cavity image information data 1212 includes pronunciation-supporting visualization means (an air current display means, a resonance point display means, an articulation point display means, a vocal cord vibration display means, a muscle tension display means 116, etc.). FIG. 38 illustrates the spirit of the present invention in which the oral cavity image information processing module 1200 receives selection information for a pronunciation-supporting visualization means (S2-31), receives oral cavity image information corresponding to the pronunciation-supporting visualization means (S2-32), and then provides the oral cavity image information corresponding to the pronunciation-supporting visualization means (S2-33).

Vocalizing oral cavity image data according to such pronunciation-supporting visualization means may be separately included in pronunciation-supporting visualization means-specific oral cavity image data 1212-1. The pronunciation-supporting visualization means-specific oral cavity image data 1212-1 is useful particularly when vocalizing oral cavity image information is provided through a plurality of layers, or when layers are present according to pronunciation-supporting visualization means and stacked and provided as one visual result to the user. In this case, an emphasis mark may be provided to a particular layer. For example, when there is a separate air current display layer, a strong color is applied to an air current mark, and when the outline of the air current is thickly displayed and such an air current display layer is combined with other layers and displayed as vocalizing oral cavity image information to the user, the air current mark is shown further clearly.

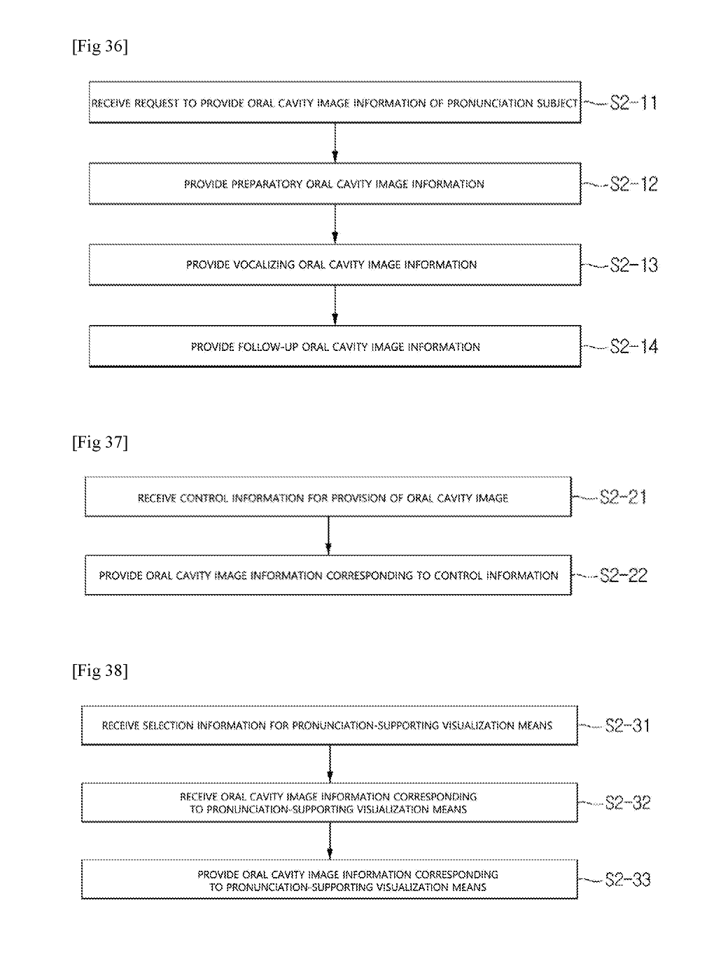

When the user input-based oral cavity image processor 1230 receives emphasis selection information for an air current mark from the user terminal 2000, it may be further effective to use layers. FIG. 36 illustrates the spirit of the present invention in which the user input-based oral cavity image processor 1230 receives control information for provision of an oral cavity image (S2-21), and provides oral cavity image information corresponding to the control information (S2-22). The control information may be speed control, a transmission request for image information other than preparatory oral cavity image information or follow-up oral cavity image information, a request for a particular pronunciation-supporting visualization means, and a selection of a tone, etc.

Meanwhile, the oral cavity image information processing module 1200 may be produced by using or not using layers. However, while layers are removed from an image finally provided to the user terminal 2000, a single image in which an air current mark is emphasized may be generated. It is self-evident that, when selection information for emphasizing an air current mark is received from the user terminal 2000, a single image having an emphasized air current mark can be provided. Such provision of image information to the user terminal 2000 is performed by the oral cavity image providing module 1220. The oral cavity image combiner/provider 1221 performs the function of combining the preparatory oral cavity image information, the vocalizing oral cavity image information, and the follow-up oral cavity image information, and providing the combined oral cavity image information, and the integrated oral cavity image provider 1222 performs the function of providing integrated oral cavity image information which has been combined in advance.

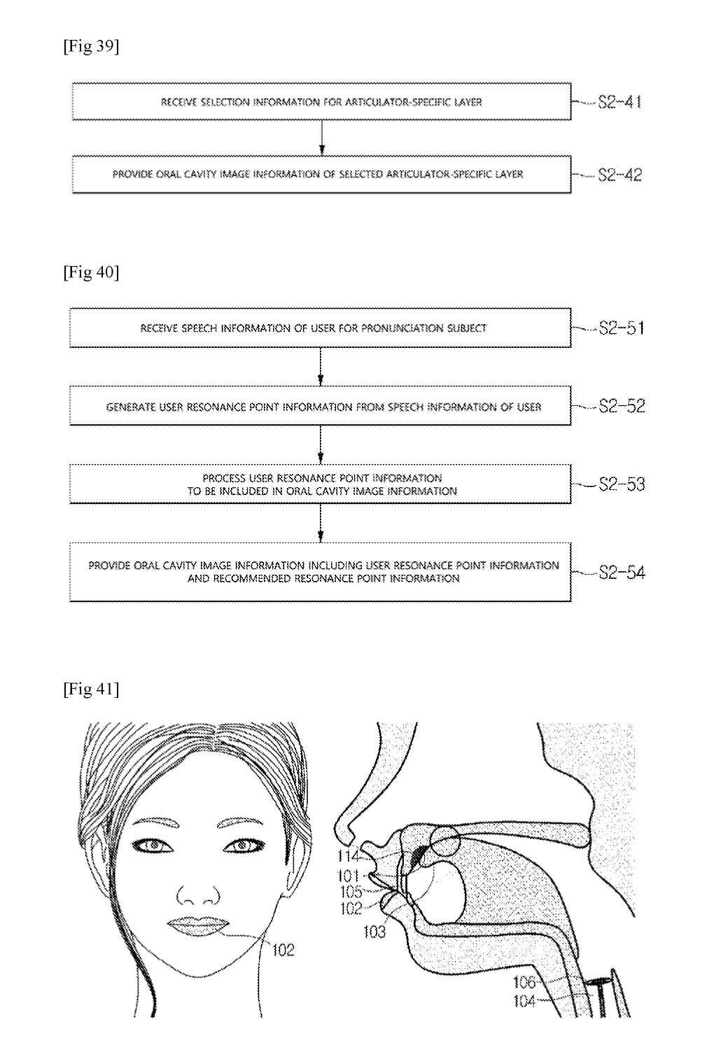

FIG. 39 illustrates the spirit of the present invention for oral cavity image information processed as layers according to articulators in which the oral cavity image information processing module 1200 receives selection information for an articulator-specific layer (S2-41), and provides oral cavity image information of the selected articulator-specific layer (S2-42).

FIG. 40 illustrates the spirit of the present invention in which the oral cavity image information processing module 1200 is supported by the resonance point generator 1710, a position display information processor 1730, etc. to receive the user's speech information for a pronunciation subject from the user terminal 2000 (S2-51), generate user resonance point information from the speech information of the user (S2-52), process the user resonance point information to be included in an oral cavity image information (S2-53), and provide oral cavity image information including the user resonance point information and recommended resonance point information (S2-54). In FIG. 55, it is possible to see that a resonance point (an image shown in a star shape) of the user is located in vocalizing oral cavity image information. By comparing the accurate recommended resonance point and his or her own resonance point, the user can correct his or her pronunciation more accurately and precisely.

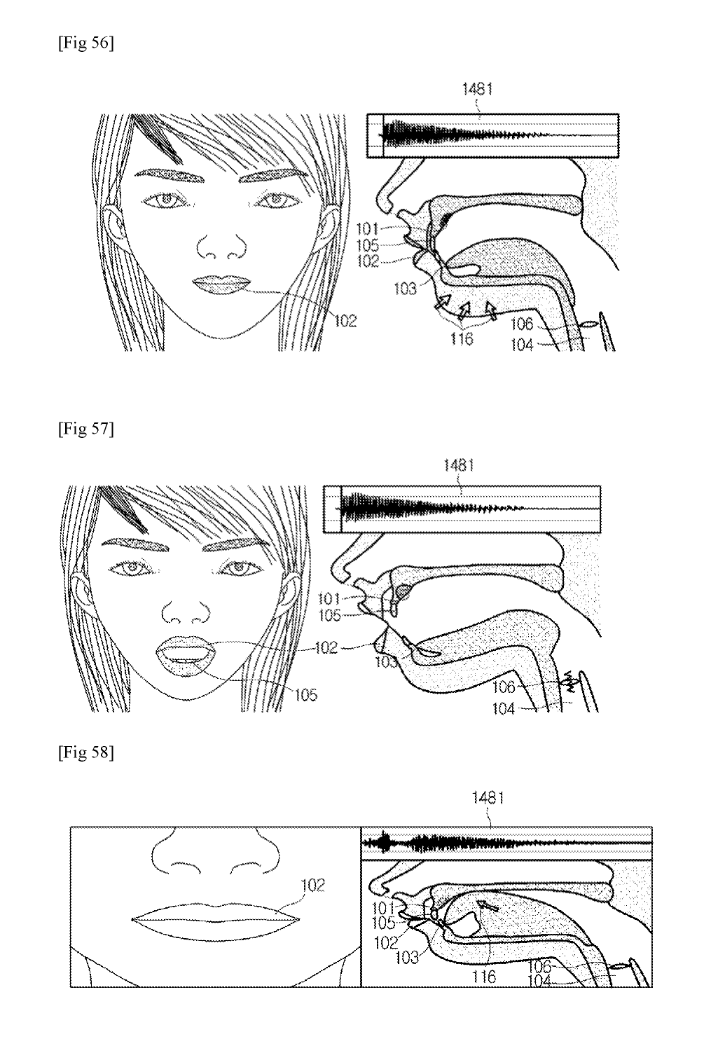

Meanwhile, in the case of plosives [p, b, t, d, k, g] and affricates [t∫, ts, d₃, [symbol] , [symbol] ] pronounced by closing a particular articulatory position through sudden contraction of facial muscles or tongue muscles in the oral cavity among particular consonants, it is possible to facilitate learners' understanding of the position of an articulator to which force is exerted by displaying a direction in which muscles of the articulator are contracted, that is, the force is exerted, when the learners learn pronunciation. FIGS. 56 to 59 are images in which vocalizing oral cavity image information reflects the muscle tension display means 116 according to an exemplary embodiment of the present invention. FIGS. 56 and 57 show parts of video constitution images in which jaw muscles tense and relax. The tension of muscles can also be indicated by an arrow or so on. FIG. 58 shows a part of a video constitution image in which tongue muscles tense and relax.

Next, a preferable way in which image data is displayed in a video according to characteristics of each phoneme will be described with examples.

A plosive is a sound which is explosively produced at once by air compressed around an articulatory position sealed by completely closing a particular position (articulation point) at a time point when the articulation point is opened. Therefore, from a time point when the tongue comes in contact with the articulation point until just before a time point when a speech signal is played, it is preferable to play image frames having the same front image and the same side image of the oral cavity, and before the speech signal is played, it is preferable to display only a change in the flow of an air current passing through the vocal cords by changing the position of an arrow over time. As the speech signal is played, an image in which the tongue is separated from the articulation point is played. Also, an arrow image passing through the vocal cords and reaching close to the articulatory position is lowered in contrast over time and finally disappears at a time point when movement of the tongue separated from the articulation point completely stops. While an arrow image behind the articulation point is lowered in contrast, an arrow showing a process of the compressed air becoming a plosive sound is displayed in front of the articulation point, that is, a position close to the outside of the oral cavity. In this way, the learner is supported in understanding a change in the air current.

A fricative is a frictional sound of air which has come upward from the lungs and been slightly compressed around the articulation point and continuously leaks from a narrow gap, that is, resistance, at a particular position (articulation point) in the oral cavity. Therefore, from a time point when the tongue fully reach the articulatory position until just before a time point when a speech signal is played, it is preferable to play image frames having the same front image and the same side image of the oral cavity, and while the speech signal is played, it is preferable to display only a change in the flow of an air current passing through the vocal cords by changing the position of an arrow over time. As the speech signal is played, an arrow image which passes through the vocal cords and moves out of the oral cavity over time is maintained until a time point when the played speech signal ends, is lowered in contrast when the playing of the speech signal ends, and finally disappears. In other words, a change in the flow of an air current at the articulatory position is indicated by an arrow over time, thereby facilitating the learner's understanding of a position of the air current and a change in the air current upon pronunciation.

An affricate is a sound of air which has been compressed around an articulatory position sealed by completely closing a particular position (articulation point) and leaks due to a high pressure at a time point when the articulation point is opened. Therefore, from a time point when the tongue comes in contact with the articulation point until just before a time point when a speech signal is played, it is preferable to play image frames having the same front image and the same side image of the oral cavity, and before the speech signal is played, it is preferable to display only a change in the flow of an air current passing through the vocal cords by changing the position of an arrow over time.

As the speech signal is played, an image in which the tongue is separated from the articulation point is played. Also, the image of an arrow passing through the vocal cords and reaching close to the articulatory position is lowered in contrast over time and finally disappears at a time point when movement of the tongue separated from the articulation point completely stops. While the image of an arrow behind the articulation point is lowered in contrast, an arrow showing a change in the rapid flow of compressed air is displayed in front of the articulation point, that is, a position close to the outside of the oral cavity, thereby facilitating the learner's understanding of a change in the air current. When the playing of the speech signal ends, an arrow moving out of the oral cavity is lowered in contrast and finally disappears.

A nasal is a sound of air that continuously leaks through the nasal cavity until vocalization of the vocal cords ends due to the flow of an air current directed to the nasal cavity when a particular position is completely sealed and a part of the tongue, which is closed for pronunciations other than nasals in contact with the soft palate and the pharynx close to the uvula, is open due to the descent of the soft palate. Therefore, the soft palate is open downward in all images before and after playing of a speech signal, and a time point when the tongue reach the articulation position and a time point when the speech signal is played are synchronized. Thereafter, when image frames having the same front image and the same side image of the oral cavity are played and the speech signal is played, it is preferable to display only a change in the flow of the air current passing through the vocal cords and the nasal cavity by changing the position of an arrow over time.

As the speech signal is played, an arrow image which passes through the articulation point and moves out of the oral cavity over time is maintained until a time point when the played speech signal ends, is lowered in contrast when the playing of the speech signal ends, and finally disappears. In other words, a change in the flow of the air current at the articulatory position is indicated by an arrow over time, thereby facilitating the learner's understanding of a position of the air current and a change in the air current upon pronunciation.

In the case of sonorants, such as [w, j], among consonants, it is preferable to synchronize images showing changes in the articulatory position and the flow of an air current, a position where a resonance occurs, and a change in the position over time from a time point when playing of a speech signal starts, and simultaneously display the change using a radiating image.

Next, an information processing method of the mapping pronunciation-learning support module 1300 of the pronunciation-learning support system 1000 of the present invention will be described in further detail. The Korean pronunciation [ [symbol] ] and the English pronunciation [i] have different tongue positions and different resonance points. However, most people do not distinguish between the two pronunciations and pronounce the English pronunciation [i] like the Korean pronunciation [ [symbol] ]. A person who correctly pronounces the Korean [ [symbol] ] can pronounce the English pronunciation [i] more correctly when he or she is aware of an accurate difference between the Korean pronunciation [ [symbol] ] and the English pronunciation [i]. In this way, phonemes having similar phonetic values in two or more languages have double sides, that is, may be harmful or helpful. The mapping pronunciation-learning support module 1300 provides comparative image information between phonemes which are fundamentally different but have similar phonetic values, thereby supporting accurate pronunciation learning of a target language.

FIG. 60 shows a configuration of the mapping pronunciation-learning support module 1300 according to an exemplary embodiment of the present invention. The mapping language image information DB 1310 includes the target language pronunciation-corresponding oral cavity image information data 1311 storing pronunciation subject-specific oral cavity image information of a target language, the reference language pronunciation-corresponding oral cavity image information data 1312 storing pronunciation subject-specific oral cavity image information of a reference language, and the target-reference comparison information data 1313 storing comparison information between the target language and the reference language. The target language pronunciation-corresponding oral cavity image information data 1311, the reference language pronunciation-corresponding oral cavity image information data 1312, and the target-reference comparison information data 1313 may exist as separate image files or may exist as one integrated digital file according to each pronunciation subject of the target language. In the latter case, such an integrated digital file may store the integrated mapping language image information data 1314.

Table 2 below shows a mapping management information structure of the inter-language mapping processing module 1320 according to an exemplary embodiment. The plural language mapping processor 1321 of the inter-language mapping processing module 1320 processes a mapping relationship between the target language and the reference language, and the mapping relationship is stored in the pronunciation subject-specific inter-language mapping relationship information data 1322.

TABLE 2

| Target | Reference | |
|---|---|---|
| Language | Language | File Information |
| [i] | [ [symbol] ] | target_i.avi |
| [i] | [ [symbol] ] | reference_ [symbol] .avi |
| [i] | [ [symbol] ] | comparison_i_ [symbol] .avi |
| [i] | [ [symbol] ] | integrated_i_ [symbol] _avi |
| [ [symbol] ]/[:] | [ [symbol] ] | target_ [symbol] .avi |
| [ [symbol] ]/[:] | [ [symbol] ] | target_ |
| [ [symbol] ]/[:] | [ [symbol] ] | reference_ [symbol] .avi |
| [ [symbol] ]/[:] | [ [symbol] ] | comparison_ [symbol] _ [symbol] .avi |
| [ [symbol] ]/[:] | [ [symbol] ] | integrated_ [symbol] _ [symbol] .avi |
| . . . | . . . | . . . |

Meanwhile, it may be effective to rapidly vocalize n reference pronunciations in succession so as to correctly vocalize one target pronunciation. For example, the English short vowel [u] pronounced as a vowel of “book” is a separate phoneme and does not exist in Korean. However, it is possible to make a very similar sound by weakly and shortly vocalizing the Korean “ [symbol] .” Therefore, when images of pronouncing the Korean “ [symbol] ” is rapidly played and provided, a learner who learns the English pronunciation [u] can be supported in imitating the images and effectively pronouncing [u].

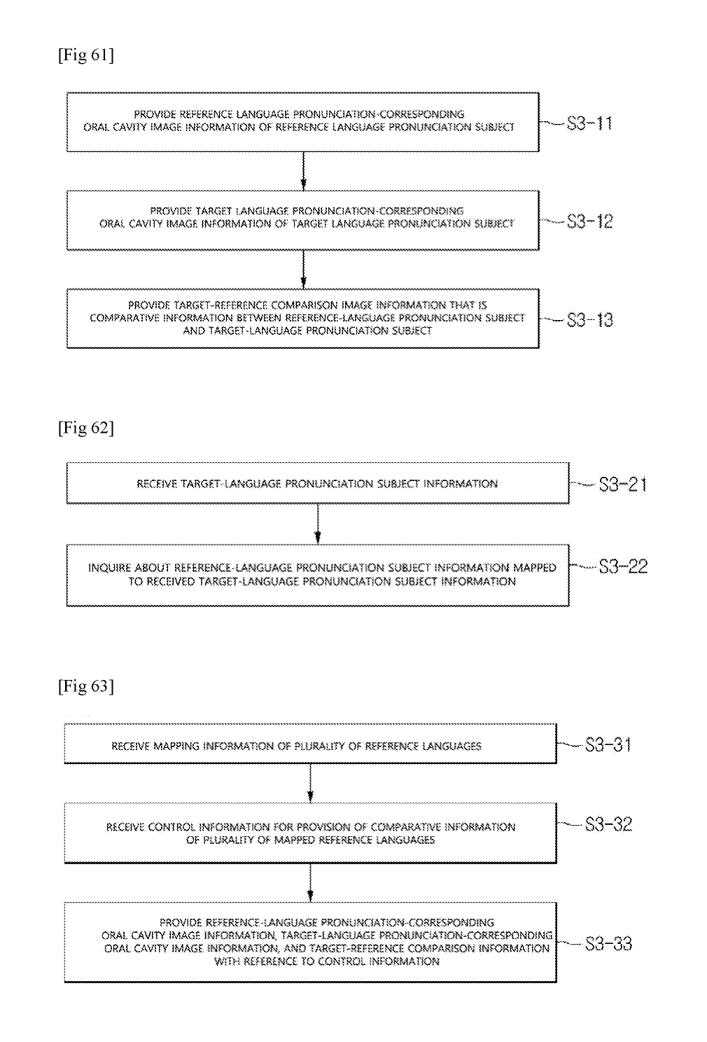

FIG. 61 illustrates an example of an information processing method of the mapping pronunciation-learning support module 1300 according to an exemplary embodiment of the present invention. The mapping pronunciation-learning support module 1300 provides reference language pronunciation-corresponding oral cavity image information of a reference language pronunciation subject (S3-11), provides target language pronunciation-corresponding oral cavity image information of a target-language pronunciation subject (S3-12), and provides target-reference comparison image information which is comparative information between the reference language pronunciation subject and the target-language pronunciation subject (S3-13).

Meanwhile, the mapping pronunciation-learning support module 1300 receives target-language pronunciation subject information from the user terminal 2000 (S3-21), and inquires about reference-language pronunciation subject information mapped to the received target-language pronunciation subject information (S3-22). For example, the user input-based 3D image processor 1130 of the mapping pronunciation-learning support module 1300 receives a target-language pronunciation subject [i] as target-language pronunciation subject information from the user terminal 2000, and acquire reference-language pronunciation subject information [ [symbol] ] by inquiring of the pronunciation subject-specific inter-language mapping relationship information data 1322 shown in Table 2.

As shown in Table 2, a plurality of target languages may be mapped to [ [symbol] ] in a reference language. In this case, as illustrated in FIG. 63, the inter-language mapping processing module 1320 acquires mapping information of a plurality of reference languages (S3-31), acquires control information for provision of comparative information of the plurality of mapped reference languages (S3-32), and provides reference language pronunciation-corresponding oral cavity image information, target language pronunciation-corresponding oral cavity image information, and target-reference comparison information with reference to the control information (S3-33).

An image included in image information provided by the mapping pronunciation-learning support module 1300 will be described below with an example. FIG. 65 shows reference language pronunciation-corresponding oral cavity image information of a reference language pronunciation subject [ [symbol] ] corresponding to [i] in a target language. While the oral cavity image information of [ [symbol] ] is output, support information for clarifying a reference language pronunciation, such as “Korean— [symbol] ,” is displayed in text. Meanwhile, oral cavity image information displayed in the user terminal 2000 shows an emphasis mark of the position, shape, and outline of the tongue (an emphasis mark 131 of the outline of the tongue for a reference-language pronunciation subject) as an oral cavity image of the Korean [ [symbol] ], and shows a recommended resonance point 133 (a point shown on the tongue) for the Korean pronunciation [ [symbol] ] as important information.

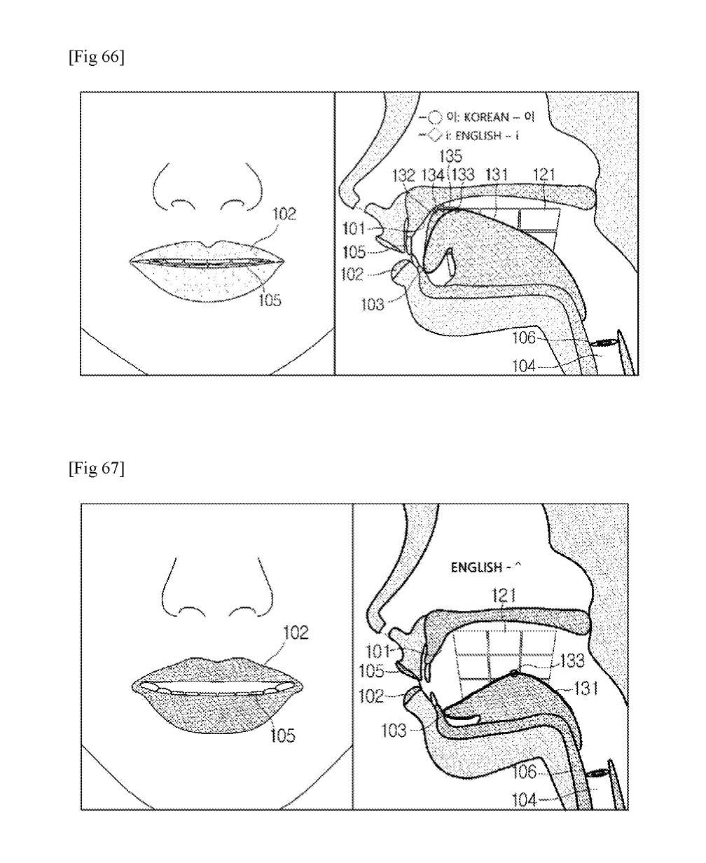

Subsequently, as shown in FIG. 66, comparative information between the target language and the reference language is displayed. At this time, while the pronunciation [i] in the target language is acoustically provided, an emphasis mark of the position, shape, and outline of the tongue (an emphasis mark 132 of the outline of the tongue for a target-language pronunciation subject) corresponding to [i] in the target language is displayed as shown in FIG. 66, and a recommended resonance point 134 corresponding to the target language pronunciation [i] and an expression means 135 (an arrow, etc. from the recommended resonance point 132 of the reference language toward the recommended resonance point 134 of the target language) representing a positional difference between a recommended resonance point of a reference language and a recommended resonance point of a target language are displayed as important information. Meanwhile, a vowel quadrilateral is displayed in FIGS. 65 and 66, thus supporting finding of relative positions of recommended positions of the reference language and the target language thereon. FIGS. 67 to 69 show another exemplary embodiment of the spirit of the present invention in which one reference language is mapped to two target languages. To support learning of a pronunciation [ [symbol] ] or [:], the mapping pronunciation-learning support module 1300 provides comparative information with a pronunciation [ [symbol] ] in the reference language.

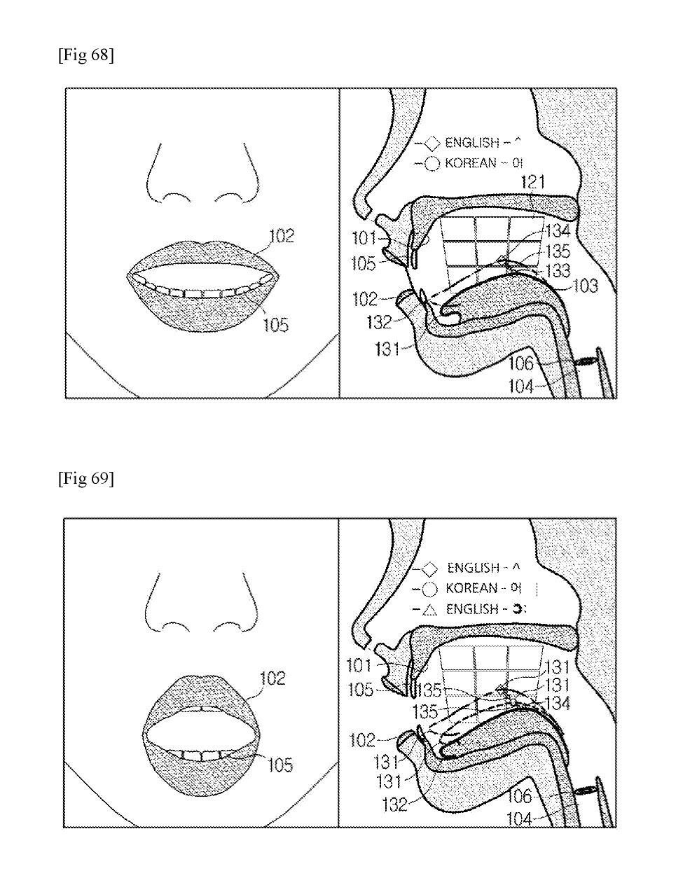

FIG. 67 is an image of oral cavity image information of the target pronunciation [ [symbol] ] in the target language according to an exemplary embodiment. All types of information on the target pronunciation [ [symbol] ] is processed as a diamond. FIG. 68 shows that oral cavity image information processed as a circle for the reference pronunciation [ [symbol] ] in the reference language is shown to overlap oral cavity image information of the target pronunciation [ [symbol] ] in the target language. Here, the oral cavity image information of the reference pronunciation [ [symbol] ] in the reference language may be displayed first, and then the oral cavity image information of the target pronunciation [ [symbol] ] in the target language may be provided as comparative information. FIG. 69 shows that an image of oral cavity image information processed as a triangle for the target pronunciation [:] in the target language is provided in comparison with the oral cavity image information processed as a diamond for the target pronunciation [ [symbol] ] in the target language and the oral cavity image information processed as a circle for the reference pronunciation [ [symbol] ] in the reference language.

As shown in FIGS. 67 to 69, a plurality of target pronunciations in a target language may correspond to one reference pronunciation of a reference language, or a plurality of reference pronunciations in a reference language may correspond to one target pronunciation of a target language. In this case, a sequence in which oral cavity image information of a plurality of reference pronunciations or a plurality of target pronunciations is displayed can be determined randomly or in consideration of selection information of the user acquired through the user input-based mapping language image processor 1340. Also, it is possible to employ a sequential provision method, such as a method of separately displaying oral cavity image information of a single/plurality of target pronunciations and/or oral cavity image information of a single/plurality of reference pronunciations and then providing target-reference comparison image information for comparing the oral cavity image information of the target pronunciations and the oral cavity image information of the reference pronunciations. As shown in FIGS. 65 to 69, when oral cavity image information of a single/plurality of target pronunciations or oral cavity image information of a single/plurality of reference pronunciations is displayed, the oral cavity image information may be provided to distinguishably overlap previously displayed oral cavity image information. Such a sequential provision method or overlapping provision method may be selected according to a selection of the user acquired by the user input-based mapping language image processor 1340 or according to an initial setting value for a provision method of the mapping pronunciation-learning support module 1300. However, regardless of provision methods, it is preferable to essentially provide the target-reference comparison information data 1313.

Here, the oral cavity image information of the target pronunciations, the oral cavity image information of the reference pronunciations, and the target-reference comparison oral cavity image information may exist as separate digital files and may be transmitted to the user terminal 2000 in order of being called. Also, it may be preferable for the oral cavity image information of the target pronunciations, the oral cavity image information of the reference pronunciations, and the target-reference comparison oral cavity image information to coexist in one integrated file.

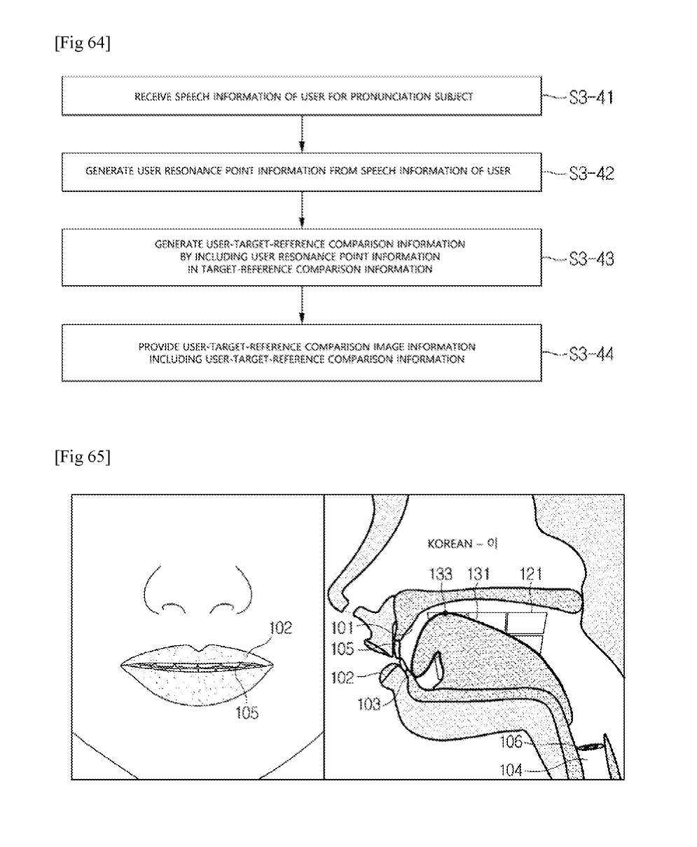

Meanwhile, the user input-based mapping language image processor 1340 may receive user speech information from the user terminal 2000 and generate resonance point information by processing the user speech information. Generation of the resonance point information has been described above. As described above, the generated resonance point can be applied to the oral cavity image information of the target pronunciations, the oral cavity image information of the reference pronunciations, and the target-reference comparison oral cavity image information. FIG. 64 illustrates the spirit of the present invention in which such user speech information is processed to maximize the effects of pronunciation learning. The mapping pronunciation-learning support module 1300 acquires the user's speech information for a pronunciation subject (S3-41), generates user resonance point information from the user's speech information (S3-42), generates user-target-reference comparison information by including the user resonance point information in target-reference comparison information (S3-43), and then provides user-target-reference comparison image information including the user-target-reference comparison information (S3-44).

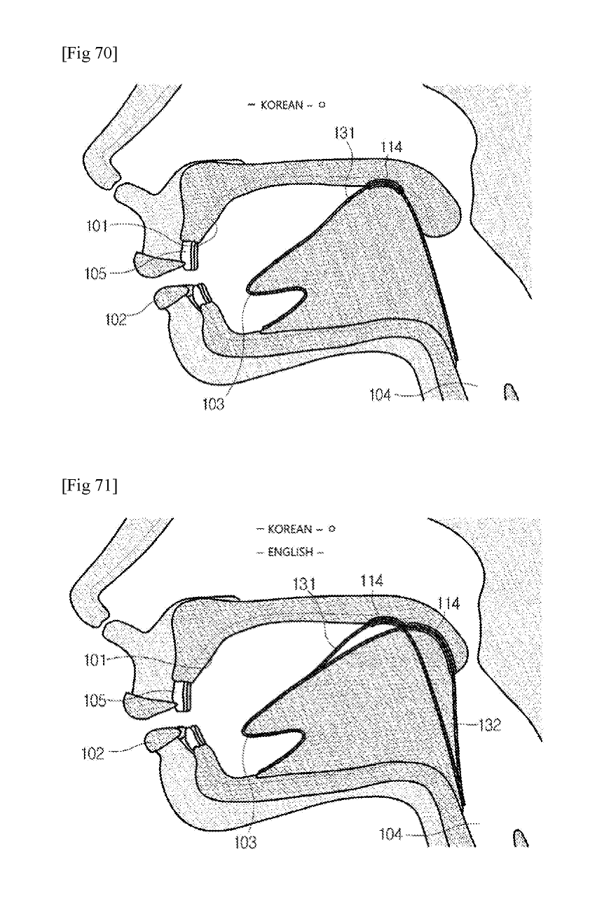

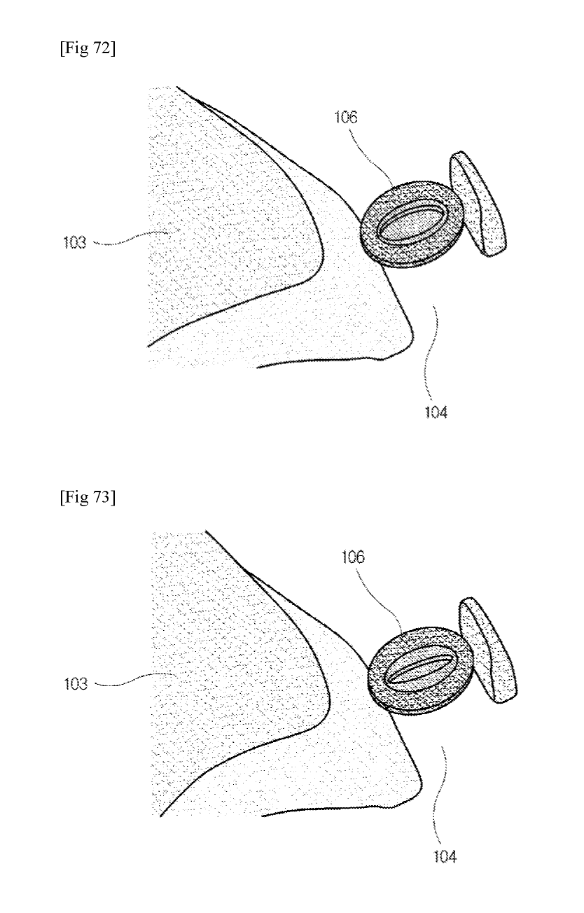

FIGS. 70 to 73 are diagrams showing a configuration of a video to which the spirit of the present invention regarding consonants is applied according to an exemplary embodiment. FIG. 70 shows oral cavity image information of the Korean pronunciation [◯] as a reference pronunciation, and FIG. 71 is a diagram of an oral cavity image in which a reference pronunciation and a target pronunciation are comparatively displayed. FIG. 72 shows vocal cord image information of the Korean pronunciation [ [symbol] ] as a reference pronunciation, and FIG. 73 is a diagram of a vocal cord image for the target pronunciation [h]. From the comparison between FIGS. 72 and 73, it is possible to intuitively understand that the English pronunciation [h] can be correctly made by narrowing the vocal cords compared to the Korean pronunciation [ [symbol] ].

In the above examples, a target language is an English pronunciation, and a reference language is a Korean pronunciation. However, this is merely an example, and those of ordinary skill in the art will appreciate that the spirit of the present invention can be applied to any combination of a target language and a reference language as long as there is a mapping relationship between the languages. Meanwhile, it is self-evident that a plurality of reference languages can correspond to one target language.

### INDUSTRIAL APPLICABILITY

The present invention can be widely used in the education industry, particularly, the foreign language education industry and industries related to language correction.

1. A method of processing information by a pronunciation-learning support system, the method comprising the steps of:
(a) acquiring at least a part of recommended air current information data including strength and direction information of an air current flowing through an inner space of an oral cavity during vocalization of each of pronunciation subjects and recommended resonance point information data including information on a position on an articulator where a resonance occurs during the vocalization of the pronunciation subject; and
(b) when a particular pronunciation subject is selected from among the pronunciation subjects, providing an image by performing at least one of a process of displaying particular recommended air current information data corresponding to the particular pronunciation subject in the inner space of the oral cavity in an image provided based on a first see-through direction and a process of displaying particular recommended resonance point information data corresponding to the particular pronunciation subject at a particular position on an articulator in the image provided based on the first see-through direction.

2. The method of claim 1, wherein step (b) includes, when the pronunciation-learning support system identifies the particular pronunciation subject pronounced by a user, providing an image by performing at least one of the process of displaying the particular recommended air current information data corresponding to the particular pronunciation subject in the inner space of the oral cavity in the image provided based on the first see-through direction and the process of displaying the particular recommended resonance point information data corresponding to the particular pronunciation subject at the particular position on the articulator in the image provided based on the first see-through direction.

3. The method of claim 1, wherein, when a direction in which a user of the pronunciation-learning support system looks at a screen is identified as a first direction according to a technology for recognizing a gaze of a user or a technology for recognizing a face of a user, the first see-through direction is determined with reference to the first direction.

4. The method of claim 3, wherein step (b) includes, when it is identified that the direction in which the user looks at the screen has been changed to a second direction while the image is provided in the first see-through direction, providing the image processed based on the first see-through direction and an image processed based on a second see-through direction stored to correspond to the second direction.

5. The method of claim 1, wherein step (a) includes the steps of:
(a1) acquiring vocalization information according to the pronunciation subjects from a plurality of subjects;
(a2) conducting a frequency analysis on the vocalization information acquired according to the pronunciation subjects; and
(a3) acquiring the recommended resonance point information data with reference to F1 and F2 which are two lowest frequencies among formant frequencies acquired through the frequency analysis.

6. The method of claim 1, wherein, when a vocalization of a user of the pronunciation-learning support system for the particular pronunciation subject is detected, step (b) includes the steps of:
(b1) acquiring actual resonance point information data of the user for the particular pronunciation subject from the detected vocalization; and
(b2) providing an image by separately displaying the particular recommended resonance point information data stored to correspond to the particular pronunciation subject and the actual resonance point information data at corresponding positions on the articulator in the image provided based on the first see-through direction.

7. The method of claim 1, wherein the articulator is n in number,
metadata for processing at least some of the articulators as different layers is stored, and
when the particular pronunciation subject is selected by a user of the pronunciation-learning support system, an image is provided by activating a layer corresponding to at least one particular articulator related to the particular pronunciation subject.

8. A recording medium including a computer-readable program for performing the method of claim 1.

9. A method of processing information by a pronunciation-learning support system, the method comprising the steps of:
(a) (i) acquiring at least a part of preparatory data including information on a state of an inner space of an oral cavity and states of articulators before a vocalization of each of pronunciation subjects, (ii) acquiring at least a part of recommended air current information data including strength and direction information of an air current flowing through the inner space of the oral cavity during the vocalization of the pronunciation subject and recommended resonance point information data including information on a position on an articulator where a resonance occurs during the vocalization of the pronunciation subject, and (iii) acquiring at least a part of follow-up data including information on a state of the inner space of the oral cavity and a state of the articulator after the vocalization of the pronunciation subject; and
(b) when a particular pronunciation subject is selected from among the pronunciation subjects, providing an image by performing (i) a process of providing preparatory oral cavity image information by displaying information on a state of the inner space of the oral cavity and a state of an articulator included in particular preparatory data corresponding to the particular pronunciation subject, (ii) a process of providing vocalizing oral cavity image information by displaying at least a part of particular recommended air current information data and particular recommended resonance point information data corresponding to the particular pronunciation subject in the inner space of the oral cavity and in at least some positions on the articulator, and (iii) a process of providing follow-up oral cavity image information by displaying information on a state of the inner space of the oral cavity and a state of the articulator included in particular follow-up data corresponding to the particular pronunciation subject.

10. The method of claim 9, wherein step (a) includes additionally acquiring information on a vowel quadrilateral through a process including the steps of:
(a1) calculating ranges in which a resonance may occur during pronunciation of a vowel in the oral cavity according to language, sex, and age;
(a2) calculating an average of the calculated ranged in which a resonance may occur; and
(a3) setting a section with reference to the calculated average, and
step (b) includes, when the vowel is included in the selected particular pronunciation subject, inserting a vowel quadrilateral corresponding to the particular pronunciation subject in at least some of the preparatory oral cavity image information, the vocalizing oral cavity image information, and the follow-up oral cavity image information to provide the vowel quadrilateral.

11. The method of claim 9, wherein step (a) includes the steps of:
(a1) acquiring vocalization information according to the pronunciation subjects from a plurality of subjects;
(a2) conducting a frequency analysis on the vocalization information acquired according to the pronunciation subjects; and
(a3) acquiring the recommended resonance point information data with reference to F1 and F2 which are two lowest frequencies among formant frequencies acquired through the frequency analysis.

12. The method of claim 9, wherein, when a vocalization of a user of the pronunciation-learning support system for the particular pronunciation subject is detected, step (b) includes the steps of:
(b1) acquiring actual resonance point information data of the user for the particular pronunciation subject from the detected vocalization; and
(b2) providing an image by performing a process of separately displaying the particular recommended resonance point information data stored to correspond to the particular pronunciation subject and the actual resonance point information data at corresponding positions on the articulator and providing the vocalizing oral cavity image information.

13. The method of claim 9, wherein the articulators are n in number,
metadata for processing at least some of the articulators as different layers is stored, and when the particular pronunciation subject is selected by a user of the pronunciation-learning support system, an image is provided by activating a layer corresponding to at least one particular articulator related to the particular pronunciation subject.

14. A recording medium including a computer-readable program for performing the method of claim 9.

15. A method of processing information by a pronunciation-learning support system, the method comprising the steps of:
(a) acquiring at least a part of recommended air current information data including on strength and direction information of air currents flowing through an inner space of an oral cavity during vocalizations of pronunciation subjects in target languages and pronunciation subjects in reference languages corresponding to the pronunciation subjects in the target languages and recommended resonance point information data including information on positions on articulators where a resonance occurs during the vocalizations of the pronunciation subjects; and
(b) when a particular target language is selected from among the target languages, a particular reference language is selected from among the reference languages, a particular target-language pronunciation subject is selected from among pronunciation subjects in the target language, and a particular reference-language pronunciation subject is selected from among pronunciation subjects in the particular reference language, providing an image by (i) performing at least one of a process of displaying first particular recommended air current information data corresponding to the particular target-language pronunciation subject in the inner space of the oral cavity and a process of displaying first particular recommended resonance point information data corresponding to the particular target-language pronunciation subject at a particular position on an articulator and (ii) performing at least one of a process of displaying second particular recommended air current information data corresponding to the particular reference-language pronunciation subject in the inner space of the oral cavity and a process of displaying second particular recommended resonance point information data corresponding to the particular reference-language pronunciation subject at a particular position on the articulator.

16. The method of claim 15, wherein step (b) includes the steps of:
(b1) acquiring speech data from a vocalization of a user of the pronunciation-learning support system;
(b2) acquiring a type of the reference language by analyzing the acquired speech data; and
(b3) supporting the selection by providing types of n target languages among at least one target languages corresponding to the acquired type of the reference language in order of most selected as a pair with the acquired type of the reference language by a plurality of subjects who have used the pronunciation-learning support system.

17. The method of claim 15, wherein step (b) includes the steps of:
(b1) acquiring speech data from a vocalization of a user of the pronunciation-learning support system;
(b2) acquiring a type of the target language by analyzing the acquired speech data; and
(b3) supporting the selection by providing types of n reference languages among at least one reference languages corresponding to the acquired type of the target language in order of most selected as a pair with the acquired type of the target language by a plurality of subjects who have used the pronunciation-learning support system.

18. The method of claim 15, wherein step (a) includes the steps of:
(a1) acquiring vocalization information according to the pronunciation subjects in the target languages and acquiring vocalization information according to the pronunciation subjects in the reference languages from a plurality of subjects;
(a2) separately conducting frequency analyses on the vocalization information acquired according to the pronunciation subjects in the target languages and the vocalization information acquired according to the pronunciation subjects in the reference languages; and
(a3) acquiring the recommended resonance point information data with reference to F1 and F2 which are two lowest frequencies among formant frequencies acquired through the frequency analyses according to the vocalization information of the target languages and the vocalization information of the reference languages.

19. The method of claim 15, wherein, when a vocalization of a user of the pronunciation-learning support system for a particular pronunciation subject is detected as a vocalization of the particular target language or the particular reference language, step (b) includes the steps of:
(b1) acquiring actual resonance point information data of the user for the particular pronunciation subject from the detected vocalization; and
(b2) providing an image by separately displaying at least one of first particular recommended resonance point information data and second particular recommended resonance point information data stored to correspond to the particular pronunciation subject and the actual resonance point information data at corresponding positions on the articulator.

20. The method of claim 15, wherein the articulators are n in number,
metadata for processing at least some of the articulators as different layers is stored, and
when the particular target-language pronunciation subject or the particular reference-language pronunciation subject is selected by a user of the pronunciation-learning support system, an image is provided by activating a layer corresponding to at least one particular articulator related to the particular target-language pronunciation subject or the particular reference-language pronunciation subject.

21. A recording medium including a computer-readable program for performing the method of claim 15.
